(19) United States
(12) Patent Application Publication
(10) Pub. No.: US 2026/0310202 A1
(43) Pub. Date: Oct. 8, 2026

(54) RETRIEVAL-AUGMENTED NAVIGATION SYSTEM AND METHOD

(71) Applicant: NAVER CORPORATION, Seongnam-si (KR)

(72) Inventors: Gianluca MONACI, Grenoble (FR); Rafael SAMPAIO DE REZENDE, Montpellier (FR); Romain DEFFAYET, La Tronche (FR); Hervé DÉJEAN, Grenoble (FR); Stéphane CLINCHANT, Meylan (FR); Gabriela CSURKA KHEDARI, Meylan (FR); Christian WOLF, Fontaines Saint Martin (FR); Guillaume BONO, Crolles (FR)

(21) Appl. No.: 19/552,387

(22) Filed: Feb. 27, 2026

Related U.S. Application Data
(60) Provisional application No. 63/782,928, filed on Apr. 3, 2025.

(51) Int. Cl. G05D 1/243; G05D 107/40; G06V 10/74; G06V 10/75; G06V 20/56

(52) U.S. Cl. CPC G05D 1/2435; G06V 10/751; G06V 10/761; G06V 20/56; G05D 2107/40

(57) ABSTRACT

Methods and systems for performing a goal-oriented visual navigation task for an autonomous device in a three-dimensional navigation environment. An observation image is received. A set of images are retrieved from an image database, and a context is encoded. A current state of an agent is updated based on the encoded context for determining a next action with a learned policy for navigating the agent and controlling movement of the autonomous device.

### PRIORITY INFORMATION

This application claims priority to and benefit from U.S. Provisional Patent Application Ser. No. 63/782,928, filed Apr. 3, 2025, which application is incorporated in its entirety by reference herein.

### FIELD

The present disclosure relates generally to machine learning, and more particularly to methods and systems for navigation of autonomous devices.

### BACKGROUND

It is useful to provide an autonomous device such as a robot (e.g., terrestrial robot) or autonomous vehicle (e.g., a drone capable of driving, flying or submerging underwater, or a combination thereof) with navigation capabilities to perform various tasks in a three-dimensional navigation environment (three-dimensional environments, locations, or scenes in which real or virtual navigated movement is possible, e.g., indoor environments such as one or more rooms, hallways, entryways, or other open, enclosed, or partially enclosed areas, outdoor environments such as one or more open, enclosed, or partially enclosed areas, etc., or combinations of indoor and outdoor environments). To this end, navigation methods have been disclosed that incorporate machine learning in which, at multiple steps during operation, an agent determines navigation actions for controlling movement of the device in furtherance of carrying out a task. The agent may be trained, e.g., using reinforcement learning methods.

Conventional methods for navigation based on large-scale learning typically treat each episode as a new problem, where the agent is spawned with a clean memory in an unknown environment. However, in many settings, it would be useful for an agent to have the capacity to exploit information that has been collected during earlier operations.

### SUMMARY

Provided herein, among other things, are methods and systems for performing a goal-oriented visual navigation task for an autonomous device in a three-dimensional navigation environment using one or more processors. An example method comprises: receiving an observation image; retrieving a set of images from an image database based on at least a goal; comparing the retrieved set of images to at least the received observation image; encoding a context based on said comparing; updating a current state of an agent based on at least the goal, observation image, previous states and actions, and the encoded context; determining a next action based on the current state with a learned policy for navigating the agent; and outputting the determined next action to a control module for controlling movement of the autonomous device.

According to another embodiment, a navigation system including a retrieval-augmented agent in an autonomous device is provided, which system may be implemented by one or more processors. The navigation system comprises: an image database comprising a dataset of images; a retrieval module that retrieves a set of images from said image database based at least on a goal; an embedding module that compares the retrieved set of images to at least a received observation image and generates embeddings for the retrieved set of images; a context encoding module that generates a context based on the generated embeddings; a navigation module that updates a current state of the retrieval-augmented agent based at least on the context, the goal, a current observation, and previous states and actions; and an action determining module that determines a next action based on the current state with a learned policy for navigating the agent in the environment and outputs the selected next action to a control module for controlling movement of the autonomous device.

The navigation system may be incorporated into an autonomous device, such as a robot or autonomous vehicle, along with an image capturing device such as a camera, a control module (e.g., controller) for receiving an action output from the agent based on an observation image obtained from the image capturing device and a goal obtained from a goal source, an image database, and an actuator (e.g., a propulsion device) that receives control commands from the control module in response to the received action. In some example methods, the goal may be a goal image, which may be provided to the navigation system or may be retrieved from the dataset based on a task goal. In other example methods, the goal may be represented by text, such as for a goal corresponding to a category or class.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows information flow in an example retrieval-augmented navigation system.

FIG. 2 shows steps in an example retrieval-augmented navigation method.

FIG. 3 shows example retrieval-based augmentations for ImageNav, Instance-ImageNav, and ObjectNav tasks, according to illustrative applications of example retrieval-augmented navigation systems and methods.

FIG. 4 shows an example retrieval-augmented navigation architecture (RANa) for performing tasks according to each of the example use cases set out in FIG. 3. In FIG. 4, the dashed arrows refer to steps that may be used in some example navigation tasks but omitted in others.

FIGS. 5A-5F are images depicting examples of shortest paths on DINOv2-Graph (SWG) and on Pose Graph (PS).

FIG. 6 shows performance results of example retrieval-augmented navigation agents (RANa agents) with retrieved context on ImageNav and ObjectNav tasks.

FIGS. 7A-7C show navigation results of comparison experiments.

FIG. 8 shows results of a comparison of RANa for ImageNav with state-of-the-art (SOTA) models that finetune visual encoders based on CLIP.

FIG. 9 compares the results of RANa-t (tiny model) for ObjectNav with competing approaches.

FIG. 10A shows model sizes and runtimes (in ms) of various components of example DEBiT and RANa models, timed on one Nvidia H100-80G GPU.

FIG. 10B shows inference runtimes for example methods RANa-t Gumbel and RANa-t Graph-Attn compared to a non-augmented baseline (DEBiT-t), illustrating separate experimental runtimes for semantic FM (DINOv2), retrieval, context, other encoders, policy, and a geometric FM (Croco).

FIG. 10C compares the performance of example zero-shot ImageNav architectures for various models.

FIG. 11 shows an example implementation of successful zero-shot Instance-ImageNav task.

FIG. 12 illustrates two episodes including a challenging success case (left), where the cactus viewing angle is far from any view the agent could capture, and (right) a failure case, where the retrieval returned as goal [symbol] an image of a different instance of the same microwave model at a different position.

FIG. 13A illustrates the behavior of an example RANa-t ImageNav model when using different example strategies to create the context, FIG. 13B illustrates results comparing retrieval dataset sizes, and FIG. 13C illustrates zero-shot Instance-ImageNav performance relative to retrieval dataset size.

FIG. 14 shows performance of context element selections for ImageNav.

FIG. 15A illustrates navigation in ImageNav with “oracle” context, FIG. 15B shows an impact of GRU finetuning, with SR (SPL) form ImageNav with GRU finetuned and trained from scratch, FIG. 15C shows performance of a variant that selects context elements based only on context element and observation, compared to the baseline that uses both observation and goal, and FIG. 15D illustrates an impact of retrieval data selection on behavior.

FIG. 16A illustrates impact of database size for ObjectNav, and FIG. 16B shows results of retrieval performance of CLIP variants in the context of ObjectNav. Retrieval was considered successful if the retrieved image was of the correct category and it was closer than 1 m to the target object.

FIG. 17 shows images for experimental Context types for ImageNav including, from top to bottom, top 8 most similar dataset images to the image goal (right), top 8 MMR most similar images filtered by MMR, and DINOv2-Graph, which depended on the observation (left) as well.

FIG. 18 shows examples of images for context for different ObjectNav categories using similarity in CLIP feature space for the six example goal categories: chair, bed, plant, sofa, tv monitor, and toilet.

FIGS. 19A-B are images illustrating examples of the agent RANa-b navigating to two challenging ImageNav goals, respectively, with images depicting a failure for baseline.

FIGS. 20A-20B are images illustrating RANa-b successfully navigating to two goals in zero-shot Instance-ImageNav episodes with images depicting a failure for baseline. The agent observation is on the left, next to it is the original goal image from the Instance-ImageNav task (in cyan) and the retrieved goal image [symbol] highlighted in green. The remaining data is organized and visualized as in FIGS. 19A-19B.

FIGS. 21A-21B are images illustrating RANa-b successfully navigating to real-world goals in two zero-shot Instance-ImageNav episodes, in which the original image goal (highlighted in cyan) is taken with a smartphone in a real environment. A goal image [symbol] is retrieved from [symbol] and the agent navigates in a 3D model of the environment.

FIG. 22 shows an example system architecture in which example methods may be performed.

FIG. 23 shows an example retrieval-enhanced navigation system that may be incorporated into a device.

In the drawings, reference numbers may be reused to identify similar and/or identical elements.

### DETAILED DESCRIPTION

### Introduction

Example navigation methods and systems herein allow an agent for an autonomous device, which may also be referred to as a navigation agent, to exploit earlier information that has been collected, including previously captured images, to improve navigation when performing tasks in a navigation environment. In example methods and systems herein, the agent is augmented with retrieval features to exploit such earlier information. Such agents may thus be referred to as retrieval-augmented navigation agents, and systems and methods incorporating such agents may be respectively referred to as retrieval-augmented navigation systems and methods. Example methods may be used for navigation for individual episodes or even for continuous navigation.

Example retrieval features provided herein allow a retrieval-augmented navigation agent to obtain context information (context) by retrieving and processing images from a dataset (e.g., in a database, which generally refers to any suitable data storage) of previously-collected images and to integrate this additional context for navigation using a learned method. The previously-collected images may be collected during previous episodes in the same environment by the device or a different device, or may be otherwise obtained in any suitable manner. By “same environment,” the previous environment, location, or scene may be the same as or very similar to the current navigation environment, location, or scene with respect to a location of navigable or reference features, e.g., more than N % overlap, where N can be between 70 and 100. The retrieval-augmented navigation agent may be trained, for instance, with reinforcement learning (RL). In some embodiments, whether a prior environment is the “same” as (or sufficiently similar to) a current environment is determined operationally by one or more objective criteria. Nonlimiting examples include: (i) an environment identifier (e.g., a scene identifier or map identifier) associated with previously collected images matching that of the current operation; (ii) a localization or place-recognition check in which a current observation retrieves, from the database, at least a threshold number or proportion of images whose similarity score exceeds a threshold (e.g., cosine similarity above a threshold in a foundation-model feature space); and/or (iii) an estimated co-visibility/overlap score (e.g., predicted by a geometric foundation model) exceeding a threshold. In such embodiments, the “N % overlap” refers to a percentage of sampled observations or navigable regions for which the above similarity and/or co-visibility criterion is satisfied, thereby providing an implementation-ready test for “same environment.”

Example retrieval-augmented navigation systems and methods can retrieve and encode context from the previously-collected images in various ways. In example embodiments, context may be encoded using data-driven methods that employ one or more vision foundation models (FM), which can provide semantic and/or geometric understanding. For instance, example retrieval-augmented navigation systems and methods may exploit semantic and/or multi-modal foundation models for retrieval of previously-collected images, while exploiting geometric foundation models for context encoding to provide directional information.

In example embodiments, the disclosed retrieval-augmented navigation techniques provide a technical solution in which a navigation agent supplements its internal state with externally stored (i.e., stored apart from or outside of the agent to any practicable degree), environment-specific visual experience. In operation, the agent may access an image database of previously collected first-person observations and obtain a small set of retrieved images responsive to a goal representation (and, in some embodiments, further responsive to a current observation). The retrieved images are not merely displayed or logged; instead, they are processed to form an encoded context that is consumed by a learned navigation policy to output control actions for moving an autonomous device toward the goal.

This disclosed architecture addresses technical challenges that can arise in real-world navigation deployments, including limitations of purely reactive policies, limitations in the capacity of internal neural memory to retain useful prior experience across long horizons, and the practical difficulty of requiring explicit environment preparation or structured mapping as a prerequisite to navigation. By enabling retrieval of relevant prior observations from a potentially large database—optionally collected by the same device and/or by a fleet of devices operating in the same or substantially similar environment—the agent can leverage prior experience during inference time to improve robustness and efficiency, while remaining compatible with embodiments that do not require pre-built floorplans, externally installed localization infrastructure, or explicit semantic maps.

In some embodiments, a key technical feature is that context encoding is based on comparisons between retrieved images and the agent's current observation and/or the goal representation, such that the resulting context embeds actionable, geometry-relevant information (for example, relative pose cues, visibility/overlap cues, or other directional information). This is particularly advantageous because the policy may thereby receive compact signals that are directly correlated with how the device should move in the environment, rather than requiring the policy to infer such signals implicitly from raw images or from an unstructured list of retrieved results.

In some embodiments, a goal image is provided (or determined) and retrieval is performed to obtain images that are similar to the goal image (e.g., alternative views of the goal location). The encoded context can supply viewpoint-robust geometric cues that improve goal localization and action selection under camera viewpoint changes, partial occlusions, and perceptual aliasing, thereby improving navigation reliability and reducing failure events.

In some embodiments, retrieval is conditioned on both the goal representation and a current observation, and the retrieved set includes one or more images that serve as intermediate goals (pseudo-waypoints) between a current position of the agent and the goal location. A context encoder may select one or a subset of the retrieved images based on comparisons to the current observation and to the goal, thereby producing a pseudo-waypoint image that is “between” the observation and the goal in terms of visual/geometric compatibility. This dynamic context can reduce exploration overhead, support navigation through multi-room environments, and improve robustness when the goal is outside the current field of view.

In some embodiments, the goal is specified as semantic information (e.g., a category represented by text or other semantic representation). Retrieval may employ a semantic or multimodal model to retrieve database images likely to depict instances of the goal category. The resulting context can bias exploration toward likely goal locations without requiring construction of an explicit semantic map. In certain embodiments, the retrieved information may additionally be used to determine an image-goal proxy (e.g., a retrieved image semantically aligned with the object goal), allowing an image-goal navigation policy to be reused for semantic goals and thereby reducing training burden while preserving technical performance across modalities.

In some embodiments, an initial goal image may originate from a different camera, platform, or domain than the navigation agent's camera. Retrieval may therefore be used to identify and substitute a database image that is more compatible with the agent's observation model (e.g., a closest-matching database image captured with the agent's camera configuration), and the substituted goal image (and/or additional retrieved context) may then be used to guide navigation. This can enable cross-domain and cross-device operation, including zero-shot use cases, by reducing sensitivity to camera mismatch and domain shift.

In some embodiments, the system determines context iteratively over time, such that a first selected pseudo-waypoint guides the agent to a region where a subsequent pseudo-waypoint (or the final goal) becomes visible or easier to localize. This supports navigation in cases where the most informative intermediate visual cues are not co-visible with the final goal from the starting location.

In various embodiments, retrieval may be implemented using efficient nearest-neighbor search over stored representations (including approximate search), and context selection may be implemented using a trained selector, a differentiable selection mechanism, and/or a rule-based selection criterion. In this manner, the system can scale to large databases and can trade off runtime compute versus performance by adjusting retrieval size and selection behavior, while maintaining a consistent interface between retrieval, context encoding, and the learned navigation policy.

The embodiments described herein may be used individually or in combination, and the disclosed components (retrieval, context encoding/selection, state update, and policy action selection) may be implemented in hardware, software, firmware, or any combination thereof, as further described below.

### Challenges in Navigation Tasks

An example setting for device navigation is the so-called unboxing scenario, in which an autonomous device such as a robot (e.g., a terrestrial robot) is placed in a target setting providing a navigation environment, is activated, and is given a task that requires it to navigate “out of the box”; that is, without any dependency on environmental preparation such as scanning the environment, installing an external localization system, generating a floor plan, etc., prior to navigation. While such a setting can be useful in some instances, it is also useful for a robot to benefit from knowledge from prior access to the environment, such as during a prior episode by the device or a similar device. In other words, it may not always be optimal for an agent to consider every episode in a robot's life as it were its first.

For instance, during an operation of a task in an environment, whether by the same robot or a different one, valuable experience can be gained for performing additional tasks in the same environment. A scene in the environment can be explored, for instance, objects and their locations can be observed, affordances found, failure cases encountered, etc. It is thus highly useful to exploit such experience to configure navigation agents for such devices to avoid redundant exploration of previous observed data, for instance, so that the agents can learn from their previous experiences (e.g., episodes), including mistakes.

In principle, any non-reactive (that is, memory-based) navigation agent could be provided with the capacity to store information from previous episodes in internal memory. For instance, prior navigation methods employing agents having structured latent memory and trained end-to-end with reinforcement learning (RL) could perform well on navigation-related benchmarks for tasks that test the capacity of the agent to retain information from previous (sub-)goals and trajectories. However, the information these tasks need to capture has been limited in the art to positions of intermediate goal objects. Moreover, such prior navigation methods have only been demonstrated to be useful for short (multi-)episodes, e.g., of 500-2,500 agent steps, which is not optimal for continuous operations. For instance, conventional transformer-based agents with self-attention over time suffer from a limited context length and the quadratic complexity of attention, while conventional recurrent models are limited by the size of their latent memory and the network capacity growing quadratically with representation size.

Other prior methods integrate information from initial rollouts using topological maps. However, such methods require, among other things, the estimation and generation of a structured model (a graph) from a sequence of operations.

Example retrieval-augmented navigation methods herein can address one or more, up to and including all, of these concerns by retrieving information from a dataset of past experiences. For instance, a robot, or an entire fleet, can collect visual observations, e.g., images represented by image data, and store the visual observations as image information in a database such as a global database in one or more datasets. Example images may be embodied, for instance, in visual first person views (FPVs). The database can then be queried by a retrieval-augmented navigation agent during a current navigation operation to retrieve the image information, providing a context. The context can be processed in combination with other navigation inputs to determine actions to take towards a goal.

Reference herein to retrieving images likewise is intended to refer to retrieving image data or information representing such images where applicable. As explained further below, this image data can be, or can be derived from, data representing the image itself (e.g., raw image data, RBG or RGBD data, etc.), as opposed to additional or metadata for the image, though this image data may be embodied in different formats. However, it is also possible for the image data to additionally include data such as metadata.

### Example Navigation Tasks

Example goal-oriented navigation tasks can be divided into various categories depending on goal specification. One such category is point navigation (PointNav), where the agent must navigate to a relative GPS coordinate using its RGBD and odometry sensors. Example PointNav methods are disclosed in Savva et al., Habitat: A platform for embodied AI research, In ICCV, 2019; and Wijmans et al., Dd-ppo: Learning near-perfect pointgoal navigators from 2.5 billion frames, in ICLR, 2019.

Another example category is object navigation (ObjectNav), where the goal is an object category, e.g., embodied in plain text, and the agent is tasked to navigate towards an instance of the object. ObjectNav tasks require a semantic understanding of the environment (e.g., scene). Some disclosed ObjectNav methods build a semantic map or leverage a large language model (LLM) to guide navigation based on the scene's common sense semantics.

In some scenarios, ObjectNav tasks may be addressed in a zero-shot fashion, training their agents without ObjectNav rewards and leveraging CLIP encoders for goal representation, e.g., as disclosed in Gadre et al., Clip on wheels: Zero-shot object navigation as object localization and exploration, arXiv preprint arXiv:2203.10421, 3(4):7, 2022; Majumdar et al., Zson: Zero-shot object-goal navigation using multimodal goal embeddings, 2022; and Sun et al., Prioritized semantic learning for zero-shot instance navigation. arXiv preprint arXiv:2403.11650, 2024.

Still another example category is image navigation (ImageNav), in which an image is provided as a goal. Performing ImageNav tasks involves a geometric understanding of the scene. A common variant of ImageNav is instance image navigation (Instance-ImageNav), such as disclosed in Krantz et al., Navigating to objects specified by images, In CVPR, 2023. In Instance-ImageNav, the goal image depicts a specific object in the environment and is taken with camera parameters that are different from those of the agent.

### Other Control Methods

Some prior control methods for reinforcement learning have acted on successful experiences by re-employing Q-value estimates to enhance sample efficiency, such as those disclosed in Blundell et al., Model-Free Episodic Control, arXiv:1606.04460, 2016; Hansen et al., Fast Deep Reinforcement Learning using Online Adjustments from the Past, In NeurIPS, 2019; He et al., MA-LMM: Memory-Augmented Large Multimodal Model for Long-Term Video Understanding, In CVPR, 2024; Hu et al., Generalizable Episodic Memory for Deep Reinforcement Learning, In ICML, 2021; Lin et al., Episodic Memory Deep Q-Networks, In IJCAI, 2018; and Pritzel et al., Neural Episodic Control. In ICML, 2017. However, such methods do not sufficiently leverage past experience beyond making a better use of data during training. By contrast, example retrieval-augmented navigation methods herein can use retrieved information to improve navigation performance, even enabling zero-shot task generalization.

Goyal et al., Retrieval Augmented Reinforcement Learning, In ICML, 2022, discloses augmenting an RL agent with a retrieval process parameterized as a neural network that has direct access to a dataset of past experiences, and encoding trajectory information. Humphreys et al., Large-scale retrieval for reinforcement learning, In NeurIPS, 2022, discloses a generic and scalable non-parameterized retrieval augmentation for an RL agent, where relevant operations are retrieved by approximate nearest-neighbor (NN) search on embeddings previously learned through RL training. In contrast to such methods, example retrieval-augmented navigation methods herein can leverage foundation models (FM) such as vision foundation models to process stored and retrieved information for navigation tasks. This can enable zero-shot transfer and alleviate the need to pretrain embeddings using reinforcement learning.

Other disclosed retrieval-augmented approaches employ retrieval-augmenting planning methods. For example, Kagaya et al., RAP: Retrieval-Augmented Planning with Contextual Memory for Multimodal LLM Agents, arXiv:2402.03610, 2024, discloses leveraging past experiences corresponding to a current situation and context for planning with a large language model (LLM) agent. Successful task executions are stored that include plans, actions, and observation sequences, and an action is chosen from memory based on task constraints and state similarity. Another such approach disclosed in Xie et al., Embodied-RAG: General non-parametric embodied memory for retrieval and generation. arXiv:2409.18313, 2024, constructs a hierarchical topological memory for prompting an LLM that must reason and find goals within a navigable environment. By contrast, example retrieval-augmented navigation methods herein can extract information from unstructured observations, e.g., images, even without metadata or any processing of the stored information, though it is possible in some example methods to also employ metadata and/or processed information if desired.

Example navigation methods and systems provided herein can be scalable, e.g., the dataset can be as large as needed. Further, in example methods such datasets can be queried with simpler (e.g., sub-linear) querying algorithms instead of, for instance, running a complete transformer model over it.

Example retrieval-augmented navigation methods can be applied to various types of navigation, such as but not limited to ObjectNav, ImageNav, and Instance-ImageNav. Whether the goal is specified as an image (ImageNav; Instance-ImageNav) or as a semantic category (ObjectNav) depending on the task, first-person views (FPVs) can provide the retrieved information in example methods.

### Retrieval-augmented Navigation System

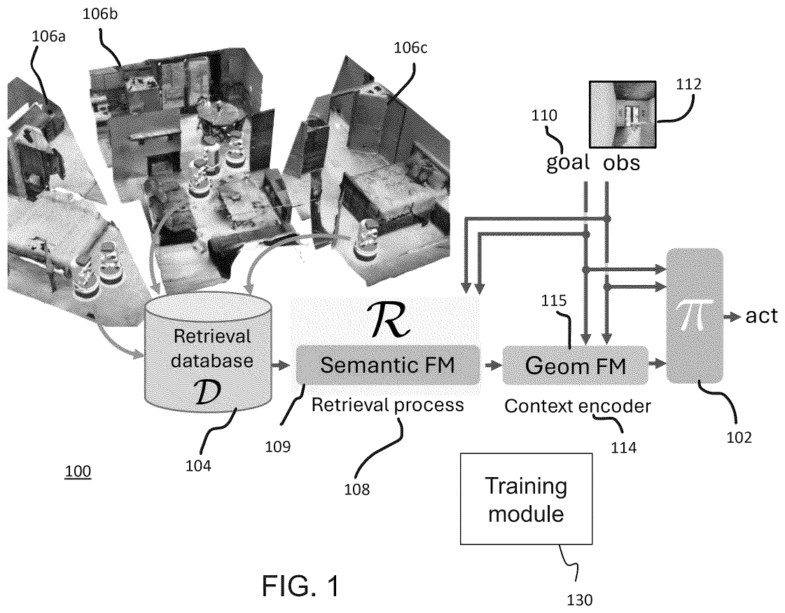

Referring now to the drawings, FIG. 1 shows information flow in an example retrieval-augmented navigation system 100. A navigation agent 102 that determines an action according to a learned policy rc is augmented with context retrieved from an environment-specific, e.g., scene-specific, retrieval database 104. The retrieval database 104 may be populated by, for instance, images, e.g., images 106a, 106b, 106c that are previously captured, e.g., by one or more robots, which capturing may occur during one or more previous episodes. The images 106a, 106b, 106c may be represented by image data of any suitable format. The retrieval database 104 thus may also be referred to as an image database. The retrieved images 106a, 106b, 106c provide context that is processed to augment the navigation agent 102.

A retrieval model 108 can include one or more models for extracting semantic and/or geometric information, and in the example navigation system 100 includes a semantic foundation model (semantic-FM). The retrieval model 108 selectively retrieves information, e.g., one or more images, from the retrieval database 104. Retrieval may be based, for example, on a received (e.g., encoded) goal 110 from a suitable goal source, and may be further based on an (e.g., encoded) observation image 112 from an image source. In other example methods, information may be retrieved from the retrieval database 104 based on the goal 110, and without the observation image. The goal 110 may be embodied in goal images for some example tasks, or the goal may be embodied in semantic information such as but not limited to a category, e.g., represented by text or other suitable data. The semantic foundation model 108 may be multi-modal.

In some embodiments, the retrieval module constructs one or more queries using at least a goal representation and optionally a current observation representation. As a nonlimiting example, a first query is formed from the goal representation to retrieve images that are similar to the goal, and a second query is formed from the current observation representation to retrieve images that are similar to the current observation. The retrieved set may include a union, intersection, or re-ranked combination of results from the first and second queries. In one illustrative implementation, each candidate image is assigned a combined score that depends on similarity-to-goal and similarity-to-observation (optionally with weights), thereby explicitly retrieving images that are “between” the two queries (e.g., co-visible with the current observation while also being predictive of progress toward the goal).

Example retrieval mechanisms can be data-driven; that is, driven from the (e.g., raw, or unstructured) image information itself (or data derived from such image information), and may use, but need not use, metadata beyond the image information itself (e.g., beyond FPVs) for retrieval information. The retrieved information can be leveraged in example navigation methods for additional context and/or to replace the goal on the fly. This allows for zero-shot applications, among other benefits.

To provide context, a context encoder 114, e.g., a model which can include one or more models for extracting semantic and/or geometric information and in the example navigation system 100 includes a geometric foundation model 114, processes the retrieved information, e.g., images, from the retrieval model 108 and generates an encoded context. For instance, the context encoder 114 may compare the retrieved set of images, e.g., images 106a, 106b, 106c, to the observation image 112 and optionally also to the goal 110, e.g., to provide context embeddings from the images. The context embeddings may then be encoded, e.g., including selecting embeddings for one or a subset of images and/or combining context embeddings for one or a subset of images, to encode the context. The encoded context may provide, for instance, directional information.

An output of the context encoder 114 along with the (encoded) goal 110 and the observation 112 is provided to the retrieval-augmented navigation agent 102, which uses this information along with other information for navigation such as but not limited to a previous state to update a current state and to determine an action (act). For instance, a policy module of the retrieval-augmented navigation agent 102 may determine a next action based on the updated state to navigate the retrieval-augmented navigation agent towards (that is, in furtherance of) the goal indicated by goal 110.

The retrieved images 106a, 106b, 106c can provide context embodied in directional information for a geometry-based navigation approach. One or more computer vision methods may be used to implement the retrieval model 108 and/or the context encoder 114 in example retrieval-augmented navigation systems. For instance, data-driven retrieval methods can leverage features from foundation models (FM) such as vision foundation models or multimodal models (e.g., neural networks trained on a variety of (image, text) pairs), such as but not limited to the Contrastive Language-Image Pre-training (CLIP) model (e.g., Radford et al., Learning transferable visual models from natural language supervision, In ICML, 2021; Ilharco et al., Openclip, 2021) and DINOv2 (e.g., Oquab et al., DINOv2: Learning Robust Visual Features without Supervision, TMLR, 3(1), 2024) to generate candidate views. A strong geometric foundation model is useful to integrate the context and provide directional information to the agent.

The example retrieval-augmented navigation system 100 can be, but need not be, embodied in an end-to-end model. In contrast to visual navigation methods using mapping and planning, end-to-end models can learn deep representations such as but not limited to flat recurrent states, occupancy maps, semantic maps, latent metric maps, topological maps, self-attention, and/or implicit representations. Then, such methods can map these representations into actions using, for instance, reinforcement learning, imitation learning, or by maximizing navigability directly with a blind agent.

A nonlimiting example end-to-end navigation model for ImageNav can be embodied in or include a Dual Encoder Binocular Transformer (DEBiT). DEBiT leverages a geometric FM based on Cross-view Completion (CroCo), to estimate the relative pose between goal and agent's observation. Example CroCo and DEBiT features are disclosed in Weinzaepfel et al., CroCo: Self-Supervised Pretraining for 3D Vision Tasks by Cross-View Completion. In NeurIPS, 2022, and in U.S. patent application Ser. No. 18/230,414, filed Aug. 4, 2023, and Ser. No. 18/239,739, filed Aug. 29, 2023, all of which are incorporated in their entirety by reference herein.

A training module 130 may be provided for training the retrieval-augmented navigation system 100. Features of example training methods are described in further detail below.

### Retrieval-augmented Navigation Method

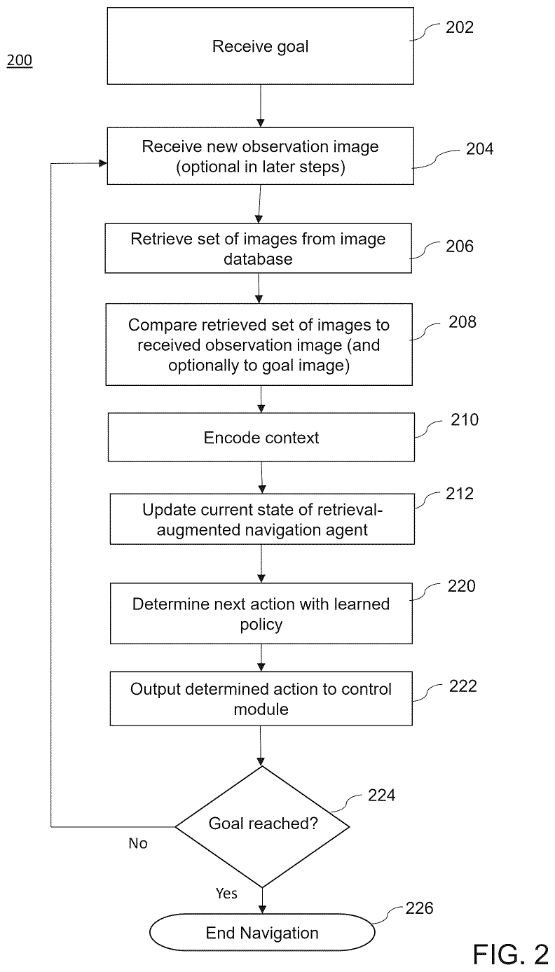

FIG. 2 shows steps in an example retrieval-augmented navigation method 200, which may be performed, e.g., by the retrieval-augmented navigation system 100. The retrieval-augmented navigation system 100 may receive a goal at 202, e.g., from the goal source 110, such as at a beginning of an episode (sequence of steps) for carrying out a navigation task.

The received goal at 202 may be, for example, a goal image. A goal image may be provided to the retrieval augmented navigation system 100 in some example methods. In other example methods the goal image may be retrieved from the image database 104 by searching the image database using criteria based on a received goal image, e.g., based on similarity to a received goal image. Retrieving the goal image from the image database 104 may be particularly useful, for instance, for Instance-Image navigation or zero-shot navigation.

In other navigation methods, e.g., object-based navigation tasks, the received goal 202 may be an object or task goal that is semantically represented, such as a category, and may be represented, for instance, by text. The task goal can be used in example object-based navigation tasks employing an augmented object-based navigation agent, for instance. In some example object-based navigation methods, such as for object-based navigation tasks where an augmented image navigation-based agent is used, a goal image additionally may be retrieved from the image database 104 based on the task goal and used for performing navigation steps. For instance, a goal image may be retrieved that is semantically similar to the task goal (e.g., text describing an object in a room), such as by employing a multimodal model, a nonlimiting example of which is a visual language model (VLM).

At one or more time steps, such as but not limited at to each time step in the episode, at each of a set among multiple sets of time steps in the episode, upon request, upon an occurrence of an event, etc., the retrieval-augmented navigation system 100 may perform retrieval-augmented navigation. For instance, the retrieval-augmented navigation system 100 may receive at 204 an observation image 112, e.g., from an image source, providing the current observation. An example image source may be embodied in a camera or other image-acquiring device. A new observation image may or may not be retrieved in every time step.

The retrieval module 108 retrieves at 206 a set of images from the image database, e.g., image database 104, based on at the least the received goal, and optionally also based on the observation image. Example images in the image database 104 may include, for instance, previously collected first person view (FPV) images, which may be represented by image information (e.g., image data). The images in the image database 104 may be generated by the navigation agent 102 or by similar agents in one or more previous navigation episodes in an environment that is the same (or substantially the same) as the current navigation environment. The retrieval step 206 can include, for example, performing a query on the image database 104 according to any of various criteria, illustrative examples of which are provided herein. For queries based on an image goal and/or an observation image, similarity between images may be considered. Additionally or alternatively, semantic similarity between text and images may be considered, e.g., for queries based on an object goal.

The retrieved images from retrieval step 206 provide useful information embodied in context, which is processed in additional steps. The context may be static, where only the goal, for instance, is used to build a fixed context kept throughout the episode, or dynamic, which also depends on the current (for instance) observation and may be recomputed, e.g., at each timestep or batch of timesteps, or in response to one or more events, requests, prompts, etc.

In some embodiments the retrieval module 108 may select whether to retrieve images for static context or for dynamic context depending on the navigation task, e.g., at the start of a retrieval-augmented navigation method. Alternatively or additionally, the retrieval module 108 may select on the fly whether to retrieve images for static context or for dynamic context, e.g., depending on the perceived visibility and/or accessibility of the goal. For example, in some embodiments the retrieval-augmented navigation system 100 selects between a “goal-in-view” mode and a “goal-not-in-view” mode based on an estimated visibility of the goal from the current observation. For example, the system obtains (directly or indirectly) a goal-visibility estimate (e.g., a visibility prediction output by a binocular visual encoder or geometric foundation model) and compares the estimate to a threshold. If the goal is determined to be in view (e.g., visibility above the threshold), the system operates in a goal-in-view mode in which retrieved images are used primarily to refine goal-relative geometric information (e.g., pose/visibility cues, alternative goal views) used by the policy. If the goal is determined not to be in view (e.g., visibility below the threshold), the system operates in a goal-not-in-view mode in which retrieved images are used to propose one or more intermediate pseudo-waypoints (e.g., images selected to be between the current observation and the goal) for guiding navigation.

To provide static context, the images may be retrieved based on the goal, such as an initial goal, without also considering the (e.g., current) observation. For instance, if the goal is a goal image, the retrieved images from retrieving step 206 may include images from the image database 104 similar to the goal image based on global image similarity, e.g., as determined by a pretrained geometric foundation model (FM) or other model, to provide static context.

To provide dynamic context, on the other hand, the images may be retrieved based on both the goal and the observation. For example, for dynamic context, the retrieving at 206 may include retrieving the set of images based at least on the goal and a current observation from the received observation image. In the case of dynamic context, the retrieved images may further include images representing one or more waypoints between a current position of the agent and the goal image. In an example method incorporating waypoints, a representation of similarity between the set of images in the image database 104 (e.g., similarities between each pair of images in the set) may be constructed. A nonlimiting example representation is embodied in a similarity matrix. A first image similar to the goal (e.g., image similarity, semantic similarity, etc.) and a second image similar to the observation image (e.g., image similarity) are determined. A path along the constructed representation of similarity containing intermediate images can be determined between the first and second images. These intermediate images can represent intermediate goals or pseudo waypoints between the observation and the goal. The intermediate images, e.g., along with the first and second images, can be selected for the context.

If the goal is a category, e.g., represented by text, the retrieved images may be images that are semantically similar to the text. These images may be ranked according to their similarities between the goal and the retrieved semantically similar images, e.g., using a pretrained semantic model 109, e.g., a visual language model VLM, a nonlimiting example of which is CLIP.

Retrieved images may also be selected in part to improve diversity of the selection. For instance, a shortlist of images from the image database may be selected, and this shortlist may be reranked to improve diversity.

The context provided via the retrieved images is processed to augment the navigation-based agent. For instance, a pretrained model 115, e.g., a geometric foundation model, which may be incorporated in or separate from the context encoder 114, may compare at 208 each retrieved image in the set of retrieved images to an observation image (e.g., the received observation image), and optionally also to a goal image. Comparing step 208, for instance, can embed context for each of the retrieved images. The comparison may compare image features for each retrieved image, e.g., as represented by feature vectors, to features of the observation image (and optionally the goal image) to embed similarity among the features. Example image features are provided herein. A result of the comparing step 208 may be embodied in, for instance, one or more sets of embeddings, e.g., corresponding to each retrieved image. The embeddings may represent, for instance, similarity or overlap between each of the retrieved images and the observation image and/or both the observation image and the goal image.

The context encoder 114 then encodes the context at 210. For instance, the context encoder may select one or a subset of the retrieved images, e.g., one or more of the embeddings, having the highest similarity (e.g., overlap or correspondence) with the observation image and optionally with the observation image and the goal image. The context encoder 114 may, for example, select an image having the highest similarity and encode the embedding(s) for that image(s). In this way, the context encoder 114 may act as a selector. Alternatively or additionally, the context encoder 114 may consolidate or combine embeddings for one or more of the retrieved images and encode the consolidated or combined embeddings. The context encoder 114 may be embodied, for instance, in a neural network that is trained, e.g., end-to-end with the policy 102.

In embodiments that employ pseudo-waypoints, the context encoder (or a selection module associated with the context encoder) selects at least one retrieved image as an intermediate goal based on at least two inputs: (i) the current observation and (ii) the goal (goal image and/or goal category). In one nonlimiting example, the selection favors a candidate image (or multiple candidate images) that is (are) predicted to be co-visible (or to have high overlap probability) with the current observation—so that the candidate image(s) correspond(s) to a reachable intermediate viewpoint—while also being more goal-relevant than the current observation (e.g., higher similarity to the goal representation or predicted closer to the goal region). The selected at least one pseudo-waypoint image is then encoded as context and used by the learned policy to output navigation actions that progress from the current observation toward the pseudo-waypoint and, ultimately, toward the goal.

The resulting context is passed to the navigation agent 102, along with other inputs for object-based or image-based navigation, examples of which are provided herein. Then, the navigation agent 102 updates at 212 its current state based on at least the goal (e.g., by comparing the goal to the observation image using a pretrained comparison model), the observation image (e.g., by processing the observation image using an observation encoder or other model), and the encoded context (e.g., as determined by encoding step 210), along with, e.g., previous states and actions that may be within memory of the navigation agent. The navigation agent 102 determines at 220 a next action based on the current state with a learned policy (e.g., policy rc) for navigating the agent towards the location in the navigation environment indicated by the received goal. Determining the next action at 220 can include, for instance, selecting a next action from an action space of discrete possible actions or in any other suitable manner. The determined next action is output at 222, e.g., to a control module that is configured to control an autonomous device embodying the navigation agent.

The retrieval-enhance navigation system 100 can determine at 224 whether the navigation goal was reached, e.g., by determining whether the determined next action was “STOP” or a similar action. If the navigation goal was reached, the navigation process (e.g., episode) ends. If not, a new observation image may be, but need not always be, received at 204, to provide a current observation, and based on the current observation (the most recent received observation, either from the previous time step or a current time step), and the navigation process repeats from retrieval step 206. The information retrieved and process in subsequent timesteps may vary, e.g., depending on whether a static or dynamic context is considered, as explained herein.

### Example Retrieval-Augmented Agent

An example retrieval-augmented navigation agent will now be described more formally for illustration. Example retrieval-augmented navigation methods herein target navigation in three-dimensional (3D) navigation environments (generally, “environments”), where a navigation agent is tasked to navigate from a starting location to a goal. At each timestep t, at each of a set of timesteps, at a selected timestep, upon request, upon occurrence of an event, etc., the agent can receive an image observation xₜ. While the image can be of any suitable size and the data may take multiple forms, an example image for explaining a formal model below is xₜ∈ [symbol] ^{3×H×W} and an example image size is 112×112.

Agents in example retrieval-augmented navigation methods may be trained for a diverse range of tasks, including but not limited to those provided herein. For illustration, and without loss of generality, the formal description below will refer to example navigation tasks, namely image navigation (ImageNav) and object navigation (ObjectNav), for illustration. An example variant of ImageNav, instance image navigation (Instance-ImageNav), is also illustrated. An initial goal in each of these cases is denoted by g.

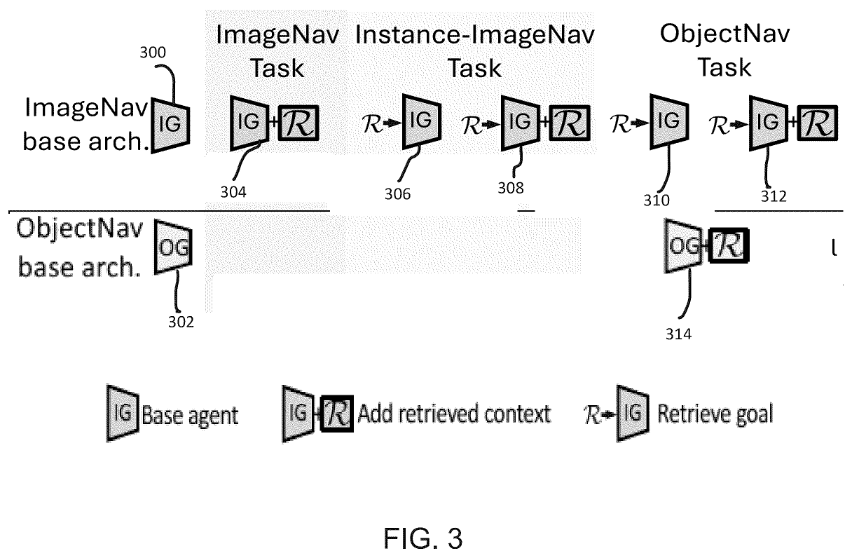

FIG. 3 shows example retrieval-based augmentation architectures for ImageNav, Instance-ImageNav, and ObjectNav tasks, according to illustrative applications of example retrieval-augmented navigation systems and methods. Example retrieval-based augmentations augment navigation agents, which are referred to herein as baseline agents or base agents. Some example systems and methods herein augment an agent that is embodied in a baseline image goal navigation base architecture (IG) 300, which is trained to navigate to a goal defined by an image. For example, the IG agent 300 may receive an additional image goal, which may be in the form gₜ∈ [symbol] ^{3×HδW} Other example systems and methods herein augment an agent that is embodied in a baseline object goal navigation base architecture (OG) 302, which is trained to navigate to a goal defined by an object. For example, the agent OG 302 may receive an object goal, which may be, as a nonlimiting example, a category g in the form of text or other suitable form.

An example action space for the agent 300, 302 is discrete, including available actions for moving (e.g., forward) a predetermined distance, turning (e.g., left) a certain amount, turning (e.g., right) a certain amount, and stopping. An action space in an illustrative example is [symbol] ={MOVE FORWARD 0.25 m, TURN LEFT 10°, TURN RIGHT 10°,STOP}. However, it is possible that the action space could be configured in other ways, including non-discrete. Navigation in the example may be considered successful, e.g., if the STOP action is selected when the agent is within a short distance from the goal, e.g., within 1 m of the goal position in terms of geodesic distance. For ObjectNav tasks, two additional actions are provided for the agent 300, 302 in an example, LOOK UP and LOOK DOWN.

Example tasks and system architectures herein can include, as nonlimiting examples, features of the ImageNav and ObjectNav tasks and base agent (IG, OG) architectures for the Habitat simulator and platform, as disclosed in Savva et al., Habitat: A platform for embodied ai research, In ICCV, 2019. However, in example architectures herein, the navigation agent for the navigation task is augmented with at least a retrieval dataset [symbol] and a retrieval module [symbol] . For instance, referring to FIG. 3, for ImageNav tasks 304, Instance-ImageNav tasks 308, ObjectNav tasks 312 using an IG base agent, and ObjectNav tasks 314 using an OG base agent, the base agent (IG or OG) may be augmented with the retrieval module [symbol] for retrieving images used to add context. Additionally or alternatively, for Instance-ImageNav tasks or zero-shot tasks 306, 308, and for ObjectNav task 310, a goal image may be retrieved using retrieval module [symbol] from the database, e.g., at runtime.

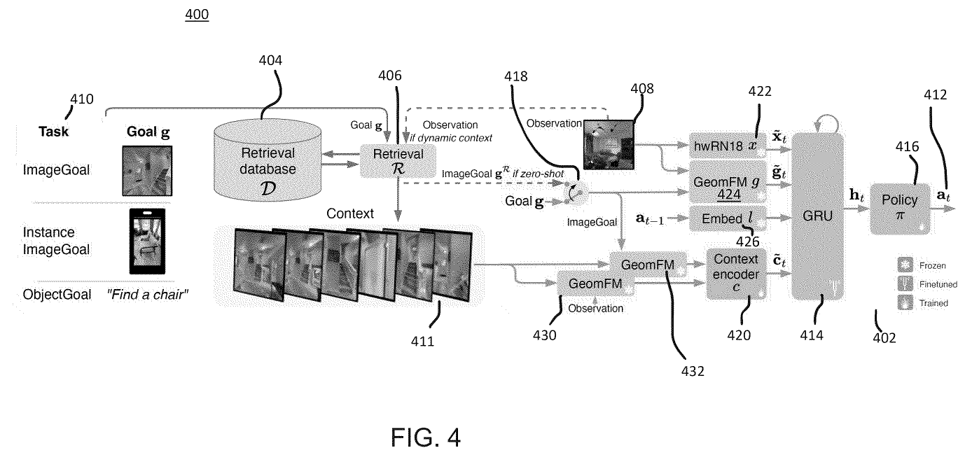

FIG. 4 shows an example retrieval-augmented navigation architecture (RANa) 400, for performing tasks according to one or more of the example use cases 304, 306, 308, 310, 312, 314 set out in FIG. 3. In FIG. 4, the dashed arrows refer to optional steps depending on the navigation task. The example architecture 400 augments an agent 402, e.g., a recurrent agent or base agent, that determines a next action for navigation.

An example dataset

$$𝒟 = \{ {x}_{i}^{𝒟} \}$$

404 contains image data for images such as first person views (FPVs) indexed by i and stemming from, for instance, previous episodes or from exploratory rollouts in the navigation environment (e.g., scene). The image data may be raw image data (e.g., without associated metadata, unstructured data, etc.), since access to FPVs alone can provide rich information to the agent. However, it is also possible to store in the dataset 402 additional data such as metadata associated to data collection, including but not limited to performed actions, reward, success or value (e.g., in a Markov Decision Process (MDP) sense, when available), pose or approximate pose of the image, position of the image, orientation of the image, etc. Additional example features of the dataset 402 and retrieval module will be described in further detail below.

The agent 402 queries the dataset [symbol] with a retrieval mechanism [symbol] 406. Querying can take place at each time step t, or for each of a set or batch of time steps up to and including all time steps in an episode (e.g., one query per episode). Querying may alternatively or additionally be performed in response to a request by the agent 402 based on one or more conditions or events. Example conditions include but are not limited to whether a new observation is sufficiently different from the previous one, whether the agent 402 has enough available compute time before taking the next action, etc. In some embodiments, if retrieval is skipped due to a compute budget, bandwidth constraint, or other condition, or if the retrieval process yields fewer than a threshold number of qualifying images (e.g., no retrieved images exceed a similarity or overlap threshold), the system sets the context to a default value (e.g., a zero vector or empty set) and the policy determines the next action based on the remaining inputs (e.g., observation, goal, and recurrent state), or in other embodiments the system may set the context to a most recently encoded context and the policy determines the next action based on the most recent context and the remaining inputs. This enables bounded-latency operation and robust control of the autonomous device even when retrieval is unavailable or uninformative. Querying may be based on the goal g 410 and optionally the current observation xₜ 408. Depending on the targeted use case and/or on other criteria the usage of the current observation image xₜ 408 in the retrieval process may be optional.

In response to the query, the retrieval-augmented agent 402 retrieves a set of images (e.g., FPVs) [symbol] (xₜ,g)→{r_{t,1},r_{t,2}, . . . r_{t,N}} 411, that may then be processed as context to improve navigation. The example retrieval mechanism can be incorporated into or augment the agent 402, which maps observations 408 and goals 410 to actions 412.

For instance, the non-augmented base agent 402 may be described as follows, where functions are denoted with italic, tensors with boldface, and encoded tensors with ~ boldface:

$$\begin{matrix}\text{?} = x ( {x}_{t} ) & // perceive\end{matrix} \qquad ( 1 )$$

$$\text{?} = g ( {x}_{t} , g ) \qquad // compare obs + goal$$

$${h}_{t} = h ( {h}_{t - 1} , \text{?} , \text{?} , l ( {a}_{t - 1} ) ) \qquad // update rec state$$

$${a}_{t} \sim π ( {h}_{t} ) , \qquad // act$$

where x and g are trainable encoders, h is the update function of a gated recurrent unit (GRU) 414, e.g., as disclosed in Cho et al., Learning Phrase Representations using RNN Encoder-Decoder for Statistical Machine Translation. In EMNLP, 2014, which GRU maintains a hidden state hₜ over time; l is an embedding function, and Ti is the policy 416. Example equations for gating functions will be understood by those of ordinary skill in the art, and are omitted herein for clarity of illustration.

Then, the retrieval-augmented agent 402 may be defined as:

$$\text{?} = x ( {x}_{t} ) \backslash \backslash perceive \\ \text{?} = g ( {x}_{t} , g ) \backslash \backslash compare obs + goal \\ \tilde{{c}_{t}} = c ( ℛ ( {x}_{t} , g ) , {x}_{t} , g ) \backslash \backslash retrieve context \\ {h}_{t} = h ( {h}_{t - 1} , \text{?} , \text{?} , \tilde{{c}_{t}} , l ( {a}_{t - 1} ) \backslash \backslash update rec state \\ {a}_{t} \sim π ( {h}_{t} ) \backslash \backslash act \qquad ( 2 )$$

where c is a context encoder 420 which combines (e.g., compresses or consolidates) the retrieved context into a compact form. In example training methods, e.g., as described in further detail below, the context encoder 420 can be trained end-to-end together with the agent 402, while the retrieval process 406 can, for instance, leverage pre-trained models. The GRU 414 may also be [symbol] fine-tuned.

In embodiments, for all tasks, an observation encoder x(xₜ), e.g., encoder 422, may control the navigation skills not related to goal directional information (e.g., estimation of navigable space, detection of walls and obstacles, etc.). The observation encoder 422 may be implemented, for instance, as a half-width ResNet-18 (hwRN18) architecture, e.g., as disclosed in He et al., Deep residual learning for image recognition. In CVPR, 2016.

The goal g, e.g., an image or a category, according to the navigation task, is compared to the observation xₜ through a dedicated comparison function g, which may be defined as

$$g ( {x}_{t} , g ) = \{ \begin{matrix}d ( {x}_{t} , g ) & if ImageNav \\ [ {cl}_{V} ( {x}_{t} ) , {cl}_{T} ( g ) ] & if ObjectNav\end{matrix} \qquad ( 3 )$$

For ImageNav, an example encoder that may be used (e.g., for comparison) is embodied in a binocular visual encoder d 424, such as disclosed in Bono et al., End-to-End (Instance)-Image Goal Navigation through Correspondence as an Emergent Phenomenon, In ICLR, 2024, and as disclosed in U.S. patent application Ser. No. 18/799,633, filed Aug. 9, 2024. The binocular visual encoder d 424 compares the current observation xₜ with the goal image g and returns an embedding containing information about the goal's direction, pose, and visibility. In some example systems, the encoder d 424 may be trained on one or more pre-text tasks, nonlimiting examples of which are disclosed in U.S. patent application Ser. No. 18/799,633. This encoder d 424 can be fine-tuned, for instance, from a geometric foundation model (FM) such as CroCo, e.g., as disclosed in Weinzaepfel et al., CroCo: Self-Supervised Pretraining for 3D Vision Tasks by Cross-View Completion, In NeurIPS, 2022, and solving as follow-up pre-text task relative-pose and visibility estimation, e.g., as disclosed in Bono et al., 2024. As a nonlimiting example, the binocular visual encoder d 424 may include first and second twin encoders and a binocular decoder that is connected to the first and second twin encoders, where the first twin encoder encodes a first image (e.g., the observation image), the second twin encoder encodes a second image (e.g., the goal image), and the binocular encoder provides an input to the navigation module based on the encoded first and second images. The binocular visual encoder 424 may be, for instance, pretrained on a first pretext task including a masked patch reconstruction task between image pairs of first images and second images, where the first images are masked, and finetuned on a second pretext task including a relative pose estimation between the first and second images and a visibility prediction, wherein the first twin encoder encodes the observation image as the first image and the second twin encoder encodes the goal image as the second image. Other encoders and/or training methods are possible, however. In an example embodiment, weights disclosed in github.com/naver/debit are used for the encoder.

In an example ObjectNav method, where a goal category is specified, a CLIP encoder may be used, e.g., such as that disclosed in Radford et al., Learning transferable visual models from natural language supervision, In ICML, 2021. The CLIP encoder can provide a semantic comparison of the observed image, encoded as cl_{V}(xₜ), and the object category, encoded as cl_{T}(g).

In some example use cases, e.g., tasks 306, 308, an image goal [symbol] can be retrieved from the retrieval dataset 404 given the task goal g, allowing an example navigation method to address tasks with the ImageNav model in a zero-shot way, e.g., for zero-shot task generalization. Alternatively or additionally, an example navigation method for tasks 310, 312 may include performing ObjectNav with an ImageNav agent by retrieving a goal image [symbol] from the retrieval dataset [symbol] 404 given a goal category. This can be integrated into the retrieval-augmented agent 402 above by adding a third case to the goal comparison function g,

$$g ( {x}_{t} , g ) = d ( {x}_{t} , {g}^{ℛ} ) if image goal is retreived \qquad ( 4 )$$

In general, the agent 402, e.g., a recurrent reinforcement learning agent, receives at each timestep (or each set of timesteps, or upon request) a new visual observation xₜ, which it encodes, e.g., via observation encoder 422, and compares with the goal g, e.g., via comparison model 424, and enriches with additional context retrieved from the database [symbol] via retrieval module [symbol] , which is encoded via context encoder 420. This enriched representation can then be passed to the agent 402, e.g., to GRU 414, for updating a state and then selecting an action based on the updated state according to a trained policy 416.

### Context Encoder

The task of the context encoder c 420 is to extract useful information from the list

$$ℛ ( {x}_{t} , g ) = {\{ {r}_{t , n} \}}_{n = 1}^{N}$$

of retrieved context images 411. To do so, example methods herein exploit the recognition that the comparison of the retrieved images 411 with the current observation 408 and with the goal 410 can be of geometric nature and can be performed by leveraging a pre-trained pose-estimator, or by a geometric foundation model (FM) that could extract a relevant directional information to be given to the agent 402.

In an example method, the same geometric FM used for the binocular encoder d (e.g., encoder 424) may be used as an embedding module to translate the context

$${\{ {r}_{t , n} \}}_{n = 1}^{N}$$

into a set of embeddings {e_{t,n}}_{n=1 . . . N} by passing them through the example binocular encoder along with the current observation (e.g., embedding module 430), and the goal image when available (e.g., embedding module 432):

$${e}_{t , n} = d ( {x}_{t} , {r}_{t , n} ) // ObjNav \qquad ( 5 )$$

$${e}_{t , n} = [ d ( {x}_{t} , {r}_{t , n} ) d ( g , {r}_{t , n} ) ] // ObjNav or ImageNav \qquad ( 6 )$$

The result of this encoding is a list of embeddings e_{t,n} (e.g., context tokens) that benefit from the rich inductive bias provided by the geometric FM, including information about pose and visibility of the context image r_{t,n} from the observed image xₜ and goal image g. Alternatively, one or both of the embedding modules 430, 432 may be provided by additional foundation models.

The context encoder 422 can then derive a general, e.g., single, combined, etc., context embedding, \tilde{c}ₜ=c( [symbol] (xₜ,g),xₜ,g) to generate a context that provides useful information to the agent 402. This may be performed by, for instance, selecting one or a subset of embeddings corresponding to images in the list, and/or by combining or compressing one or more embeddings or context tokens corresponding to images in the list.

Two illustrative methods for general context encoding are provided below, though others are possible:

Gumbel soft-max selector: The navigation agent 402 can select a single embedding from the list by predicting a distribution over items in the retrieved list followed by a Gumbel soft-max sampler, e.g., as disclosed in Jang et al., Categorical reparameterization with gumbel-softmax, In ICLR, 2017. More precisely,

$$\tilde{{c}_{t}} ∼ σ ( {\{ {α}_{n} \}}_{n = 1}^{N} ) , {α}_{n} = Linear ( {e}_{t , n} ) \qquad ( 7 )$$

where σ is the soft-max distribution over items in the list. The sampling and the computation of gradients may be performed, e.g., using the Gumbel soft-max trick disclosed in Jang et al., 2017. This method can be useful based on the pre-training of the geometric FM d in equations (5) and (6) above: the latent vector z=d(a,b) has been pre-trained to provide overlap information between images a and b, which is believed to be highly correlated with the relevance of the corresponding context item. Additionally, since the weights ai are calculated independently, the model can be zero-shot applied to any context size, e.g., at test time.

Attention-based encoder: As another example, an attention-based, e.g., transformer-based, model can be used to integrate multiple context tokens

$${\{ {e}_{t , n} \}}_{n = 1}^{N}$$

into a single combined or fused embedding, effectively changing and enriching the original embedding space. Example methods can use a transformer encoder network, a nonlimiting example including 2 layers of 4-heads self-attention. Example features of transformer layers are also provided in Vaswani et al., “Attention is all you need,” NeurIPS, 2017, and in U.S. Pat. No. 10,452,978. The output then can be determined, e.g., predicted, by concatenating the context tokens and processing them with (for example) a 2-layer multilayer perceptron (MLP).

### Training the Retrieval-Augmented Agent

In an example method, the agents 402 may be trained using proximal policy optimization (PPO), e.g., as disclosed in Schulman et al., Proximal policy optimization algorithms, arXiv preprint, 2017. The PPO can take place for up to 200 million environment steps, as a nonlimiting example. The retrieval module [symbol] 406 and the visual foundation models cl_{V}, cl_{T}, and d augmenting the agents 402, e.g., models 422, 424, 430, 432, can be configured, e.g., using previously determined weights or in any other suitable manner, and these weights may optionally be frozen during training. Training methods other than PPO may be used.

An example training method in experiments described herein kickstarts the retrieval-augmented agents from a retrieval-free baseline, demonstrating that retrieval-augmentation can integrate seamlessly into an already-trained agent. However, additional training methods may be based on other baselines.

An example reward definition includes features based on classical PointGoal (e.g., as disclosed in Chattopadhyay et al., RobustNav: Towards Benchmarking Robustness in Embodied Navigation, In ICCV, 2021) and ImageNav (e.g., as disclosed in Bono et al., Learning to Navigate Efficiently and Precisely in Real Environments, In CVPR, 2024) rewards. In an example method the reward is given as

$${r}_{t} = K \cdot {1}_{s u c c e s s} - {Δ}_{t}^{G e o} - λ , where K = 10 , {Δ}_{t}^{G e o}$$

is the increase in geodesic distance to the goal, and slack cost λ=0.01 encourages efficiency.

### Example Retrieval Mechanisms

In an example retrieval-augmented navigation method that may be used for various tasks and use cases, including those evaluated in experimental examples herein, a retrieval process includes a nearest neighbor (NN) search on representations, e.g., obtained with pretrained models. Depending on the navigation task at hand, example methods can use DINOv2, e.g., as disclosed in Oquab et al., DINOv2: Learning Robust Visual Features Without Supervision, TMLR, 3(1), 2024, for visual queries, and Open-CLIP, e.g., as disclosed in Ilharco et al., Openclip, 2021, for textual queries.

In some embodiments, representations (feature vectors) for images in the image database are computed in advance using one or more pretrained models (e.g., a vision foundation model and/or multimodal model) and stored in association with the corresponding images. A vector index data structure is constructed over the stored feature vectors to support efficient similarity search, including approximate nearest neighbor (ANN) search in sub-linear time relative to database size. During operation, a query feature vector is computed for a goal representation and/or observation image and used to retrieve top-K nearest neighbors under a similarity metric (e.g., cosine similarity or inner product). The index may be built per environment/scene (or per shard) and may be updated incrementally when new images are added (e.g., by adding new feature vectors and updating the index periodically or continuously), thereby enabling continued learning from prior episodes while maintaining bounded retrieval latency.

For use-cases that involve replacing the task goal g with a retrieved image goal [symbol] (e.g., tasks 306, 308, 310, 312) [symbol] may be set, for instance, as the nearest neighbor of g from the dataset [symbol] . For use-cases that involve building a context set to be passed to the encoder c (e.g., tasks 304, 308, 312, 314), the set of images processed to provide the context may be determined via any of various methods.

Some example methods may use a static context approach, where (e.g., only) the goal is used to build a fixed context kept throughout the episode. Other example methods may use dynamic context, which also depends on the current observation and is recomputed, for instance, at each timestep, at each set or batch of timesteps, and/or when requested by the agent 402 based on one or more conditions such as a sufficiently different new observation, the availability of sufficient computational resources, etc.

Static context: An example method builds the static context by ranking images from the dataset based on similarity with the goal and selecting the top-N nearest neighbors. Providing multiple near-duplicates to the selector might not be desirable in all methods. In the case of ObjectNav, for example, a scene may contain several instances of the class of interest, and thus it may be more suitable to provide context images showing different instances. It may thus be useful to increase diversity in the retrieved context.

An example method for increasing diversity in the retrieved context uses an approach based on a Maximum Margin Relevance (MMR) re-ranking. A ranked shortlist (e.g., top-N, an example N being 100) can be provided, for instance, by accessing an original relevance score vector ω (e.g., DINOv2 or CLIP similarities), and a similarity matrix Ω can be provided (e.g., accessed) encoding the similarity for each pair of images in the ranked shortlist. Example methods may use the same or different features as used for ω_{q}. MMR is a greedy algorithm, which chooses at each step (e.g., rank) i the element rᵢ that maximizes the following re-ranking criterion:

$$MMR ( {r}_{i} ) = β ω ( {r}_{i} ) - ( 1 - β {max}_{{r}_{j} ∈ {S}_{i - 1}} Ω ( {r}_{i} , {r}_{j} ) ) \qquad ( 8 )$$

where β∈[0,1] is a mixture parameter (in experiments herein, set to 0.5) and Sᵢ₋₁ is the set of images already selected. The top-N highest MMR are then selected.

CLIP similarity normalization: While CLIP allows one to easily compare any open-vocabulary object category with retrieval gallery images, directly ranking images by similarity to the category may be suboptimal, e.g., in the context of zero-shot image classification. To address this concern for ObjectNav, for instance, an example method can leverage the recognition that methods often target a pre-defined set of classes [symbol] (e.g., six categories in HM3D), and accordingly can rescale the score of each image in [symbol] via softmax:

$${ω}_{𝒪} ( x ) = {{e}^{c {l}_{S} ( o , x )} ( {\sum }_{{o}^{′} ∈ 𝒪} {e}^{c {l}_{S} ( {o}^{′} , x )} )}^{- 1} , \qquad ( 9 )$$

where cl_{S}(o,x) denotes the CLIP similarity of image x and object category o and [symbol] (x) is its normalized similarity.

### Dynamic Context Set

For some navigation tasks, it may be useful to build the context using not only the goal but also the current observation, for example to find intermediate goals or pseudo waypoints between the current observation and the goal. In some example methods, the context may be recomputed at each timestep or set of timesteps, and/or based on one or more conditions as described herein. The agent can determine whether to use the pseudo waypoints provided in such context when selecting a navigation action.

An example method may use an affinity graph or other constructed relationship based on similarities of images in the dataset [symbol] to find such waypoints. For instance, given the dataset [symbol] , an affinity matrix [symbol] may be constructed containing the similarity between all pairs of images in [symbol] , such as by using DINOv2 features based on DINOv2, Oquab et al., 2024. Using [symbol] , a graph can be constructed whose nodes are images [symbol] ∈ [symbol] and edges are weighted by similarity. For example, a sparse graph may be constructed in which edges (images) are connected in similarity is higher than a relatively higher threshold (a nonlimiting example being 0.75), and the weight of the edge is the similarity. As another example, a sparse binary graph may be constructed generally similar to the sparse graph, but where all of the edge weights are equal to one. The example sparse binary graph provides faster computing with a tradeoff of lower performance. In yet another example, a dense graph may be constructed in which edges (images) are connected if similarity is higher than a relatively lower threshold (a nonlimiting example being 0.4), which provides more paths.

Then, in [symbol] the example method finds the most similar images

$${r}_{1}^{{x}_{t}} and {r}_{1}^{g}$$

to the observation xₜ and goal g, respectively. Finally, the context [symbol] (xₜ,g) is populated with

$${r}_{1}^{{x}_{t}} , {r}_{1}^{g}$$

and images sampled on the shortest path in the graph between them.

### Observations and Benchmarks for Training and Evaluation

Example benchmarks will now be disclosed for providing a collection of observations that can be exploited during example training and evaluation methods, including in experiments described herein. Benchmarks may be derived, for instance, from standard Habitat Navigation tasks, e.g., as disclosed in Savva et al., Habitat: A platform for embodied ai research, In ICCV, 2019. Benchmarks may be modified to any suitable degree, though it may be useful in some example methods to provide similar modifications for training and evaluating a retrieval-augmented agent.

In example methods, both ImageNav and ObjectNav benchmarks may use the Habitat simulator and platform, e.g., as disclosed in Savva et al., 2019. For ImageNav, for instance, the Gibson dataset may be used (e.g., as disclosed in Xia et al., Gibson Env: real-world perception for embodied agents, In CVPR, 2018), which includes 72 train and 14 eval scenes, with a typical ImageNav agent configuration: height 1.5 m, radius 0.1 m, 112×112 RGB camera with 900 horizontal field-of-view (hfov) at 1.25 m from the ground.

For ObjectNav, an example method may use a dataset of 80 train and 20 eval scenes of HM3DSem-v0.2 (e.g., Ramakrishnan et al., Habitat-matterport 3D dataset (HM3D): 1000 large-scale 3d environments for embodied AI. In NeurIPS Datasets and Benchmarks Track, 2021; Yadav et al., Offline visual representation learning for embodied navigation, In Workshop on Reincarnating Reinforcement Learning at ICLR 2023, 2023; Cai et al., Bridging zero-shot object navigation and foundation models through pixel-guided navigation skill, In ICRA, pages 5228-5234, IEEE, 2024), and an agent, e.g., of height 0.88 m, radius 0.18 m, and 112×112 RGB sensor with 790 hfov placed at 0.88 m from the ground.

As an illustrative example, for each scene, a navigation method may extract 10 k FPV images to use as retrieval dataset [symbol] , using the following procedure: i) start and goal viewpoints in the scene are randomly chosen such that the goal is navigable from the start, ii) an agent is made to follow the shortest path from start to goal, and iii) after each action, the agent's RGB observation are saved as an image in the dataset [symbol] . This process can be repeated until the dataset contains 10 k images. For zero-shot experiments and ablations described below, datasets with up to 100 k images are provided. The distribution of starts and goals is chosen such that the agent covers all navigable areas, and such that the path between pairs of viewpoints are not too close to one another to simulate a prior offline exploration of the scene. During training and evaluation, the retrieval-augmented agent can select dataset images from the scene it operates in.

### Experiments

Experiments herein evaluate illustrative example retrieval-augmented navigation agent (RANa) system architectures for general navigation tasks in various representative task categories including ObjectNav, ImageNav, and Instance-ImageNav, including zero-shot cases. Experiments used benchmarks as disclosed herein. Results demonstrate that example retrieval-augmented navigation methods can allow zero-shot transfer across tasks and environments while significantly improving performance compared to conventional agent-based navigation methods.

In experiments illustrative inventive features and benefits, agents are trained and evaluated on the Habitat simulator and platform disclosed in Savva et al., 2019, according to standard ImageNav, Instance-ImageNav, and ObjectNav task definitions. Example weights for visual foundation models were obtained from their public reports.

### Model Implementation:

For the example ImageNav architecture, experiments used the default experimental setup for the Gibson dataset (Shen et al., iGibson, a simulation environment for interactive tasks in large realistic scenes, CoRR, abs/2012.02924, 2020) where the goal is a random view taken by the agent camera as in, e.g., Bono et al., 2024; Majumdar et al., SSL enables learning from sparse rewards in image-goal navigation, In ICML, 2022; Mezghani et al., memory-augmented reinforcement learning for image-goal navigation, In IROS, 2022. The agents were based on those in the DEBiT architecture, e.g., as disclosed in Bono et al., 2024, by starting from the official codebase and weights provided at https://github.com/naver/debit, but extended as described above.

Two DEBiT backbones were considered: DEBiT-b (“base”), with a binocular encoder with 55M parameters, and DEBiT-t (“tiny”), with a 17M-parameters encoder, which allows faster execution for ablation experiments described in further detail below. The corresponding retrieval-augmented models are referred to as RANa-b and RANa-t. The same agent and weights were used in a zero-shot fashion for Instance-ImageNav and ObjectNav when the task goal was replaced with a retrieved image goal (ImageNav agent augmented with retrieved goal, ImageNav agent augmented with retrieval goal and retrieved context).

For the ObjectNav base architecture with a categorical or textual goal (ObjectNav agent, ObjectNav agent augmented with retrieved context), the default experimental setup of HM3DSem-v0.2 was used (e.g., Cai et al., Bridging zero-shot object navigation and foundation models through pixel-guided navigation skill, In ICRA, pages 5228-5234, IEEE, 2024; Ramakrishnan et al., Habitat-matterport 3D dataset (HM3D): 1000 large-scale 3d environments for embodied AI, In NeurIPS Datasets and Benchmarks Track, 2021). The RGB observations were 112×112 instead of 480×640 as in the original ObjectNav definition, for loading the pretrained weights of the hwRN18 visual encoder x from DEBiT-t (e.g., as disclosed in Bono et al., End-to-End (Instance)-Image Goal Navigation through Correspondence as an Emergent Phenomenon, In ICLR, 2024). The OpenCLIP model (Ilharco et al., 2024) was used, trained on Laion-2B (Schumann et al., Laion-5b: An open large-scale dataset for training next generation image-text models, In NeurIPS, pages 25278-25294, 2022; github.com/mlfoundations/open_clip/).

Observation encoder: The example observational encoder (visual encoder x) processed an RGB input image xₜ∈ [symbol] ^{×112×112}. The encoder was implemented with a half-width ResNet-18, such as disclosed in He et al., Deep residual learning for image recognition, In CVPR, 2016, and generated an output feature \tilde{x}ₜ∈ [symbol] ⁵¹².

Goal comparison function: The goal comparison function compared the observation xₜ to the goal g. For ImageNav, the goal comparison function used the frozen binocular encoder of the DEBiT model, as disclosed in Bono, 2024, based on the geometric foundation model (FM) CroCo, as disclosed in Weinzaepfel et al., CroCo: Self-Supervised Pretraining for 3D Vision Tasks by Cross-View Completion. In NeurIPS, 2022. The example binocular encoder included a Siamese encoder E applied to both xₜ and g, and a decoder D, which combines the output of the two encoders. Both E and D were implemented with a vision transformer (ViT) architecture with self-attention layers, with D also adding cross-attention. The output of the decoder D was further compressed by a fully connected layer (which was frozen, from the DEBiT model) that projected the flattened output of D into \tilde{g}ₜ→ [symbol] ³¹³⁶.

For ObjectNav, experiments used OpenCLIP (Ilharco et al., Openclip, 2021) to encode the visual observation xₜ and the textual goal g. This process produced two features cl_{V}(xₜ)∈ [symbol] ⁵¹² and cl_{T}(g)∈ [symbol] ⁵¹², which were concatenated to generate the output \tilde{g}ₜ∈ [symbol] ¹⁰²⁴.

Action embedding: 1 encoded the previous action aₜ₋₁ into a 32-dimensional feature vector ãₜ. l was taken from the DEBiT model. For ImageNav, the DEBiT action encoder was loaded and frozen during training, while for ObjectNav the action encoder was trained from scratch, since the two tasks do not share a common action space, e.g., the task definition for ObjectNav included the additional actions LOOK UP and LOOK DOWN.

Gumbel context encoder—First Variant. A first variant of the trainable context encoder c selected one element [symbol] among the context features

$${\{ {e}_{t , n} \}}_{n = 1}^{N}$$

based on a learned relevance estimate

$${\{ {α}_{n} \}}_{n = 1}^{N} .$$

The retrieved context images were compared to the goal image (if available) and to the observation by the same frozen binocular encoder of DEBiT described above, leading to the N context features

$${\{ {e}_{t , n} \}}_{n = 1}^{N}$$

each of dimension [symbol] ^{D} where D=6272 for ImageNav or Instance-ImageNav (when the goal image is available), and D=3136 for ObjectNav. A fully connected layer Linear (D,1) (using a syntax based on Pytorch) estimated the relevance

$${\{ {α}_{n} \}}_{n = 1}^{N}$$

for each context element, and the item with largest relevance was selected using a Gumbel soft-max sampler as disclosed in Jang et al., Categorical reparameterization with gumbel-softmax, In ICLR, 2017. In the ImageNav or Instance-ImageNav cases, only the binocular feature representing the comparison between observation and context item was selected, so in all cases the context feature \tilde{c}ₜ∈ [symbol] ³¹³⁶.

Attention-based context encoder—Second Variant: A second variant of the trainable context encoder c created a context feature over the context elements

$${\{ {e}_{t , n} \}}_{n = 1}^{N}$$

computed as described for the first variant. However, in the second variant the context encoder c first reduced the dimensionality of each context feature to [symbol] ¹²⁸ through a fully connected layer Linear (D,128) (D=6272 for ImageNav or Instance-ImageNav, and D=3136 for ObjectNav), then processed them with a standard two-layer transformer encoder network (e.g., as disclosed in Vaswani et al., 2017) with four attention heads and feedforward dimension 256. The N context features were concatenated into a feature vector of size [symbol] ^{N×128} and processed by a two-layer MLP (128, 3136) with hidden dimension 128 and output dimension 3136, such that the context encoder \tilde{c}ₜ had the same dimension of that of the Gumbel context encoder.

### Recurrent Memory:

The flattened vectors [symbol] , [symbol] , [symbol] , and [symbol] , were concatenated and fed to a single-layer GRU, e.g., as disclosed in Cho et al., Learning Phrase Representations using RNN Encoder-Decoder for Statistical Machine Translation, In EMNLP, 2014, with hidden state hₜ∈ [symbol] ⁵¹². This GRU provides an “extended” version of the baseline agent's (base model) GRU without context, which is finetuned. However, since the example RANa method concatenates the context feature [symbol] to the other inputs, the GRU could not be directly finetuned as is. Thus, the example GRU of the base model was modified by padding the input weight matrices of the first layer,

$${W}_{ir}^{0} , {W}_{iz}^{0} , {W}_{in}^{0}$$

(and corresponding bias vectors

$${b}_{ir}^{0} , {b}_{iz}^{0} , {b}_{in}^{0} )$$

along the input dimension with random values. The remaining GRU matrices were initialized to the values of the baseline checkpoints and finetuned from there.

Policy: The hidden state hₜ was fed to a linear policy π composed of a linear Actor head that generates a softmax distribution over actions and linear Critic head that evaluates the current state.

All models, whether retrieval-augmented or not, were trained with PPO for 200M steps. Unless specified otherwise, the visual encoder x, action embedding l, and geometric FM d were loaded from DEBiT and kept frozen, as was the OpenCLIP encoder. For retrieval-augmented agents, the context encoder c and policy network π were learned from scratch. Compared to DEBiT and hwRN18+CLIP baseline, the GRU memory of the illustrative RANa model received the additional context input [symbol] , and therefore the DEBiT baseline GRU input matrix was expanded to reach the required dimension and finetune it.

### Finetuning and Ablation Setup

Retrieval: Two context encoding approaches were employed, Gumbel and attention-based, as well as three retrieval mechanisms based on DINOv2 and DINOv2-Graph for ImageNav base architecture, and OpenCLIP for ObjectNav tasks. Unless otherwise specified, experiments used a subset of the retrieval database of size 10 k images per scene, and context size N=8. Results for ImageNav used a retrieval dataset of size 1,000 images, except for ablation experiments.

DINOv2-Graph: The graph was built from the affinity matrix [symbol] containing the similarity between DINOv2 (Oquab et al., 2024) features of all pairs of images in [symbol] , where the nodes are images

$${x}_{i}^{𝒟}$$

∈ [symbol] and edges are weighted by similarity. Dijkstra's algorithm from the SciPy Python package, disclosed in Dijkstra, A Note on two Problems in Connexion with Graphs. Numerische Mathematik, 1:269-271, 1956, was used to select the shortest path between two nodes.

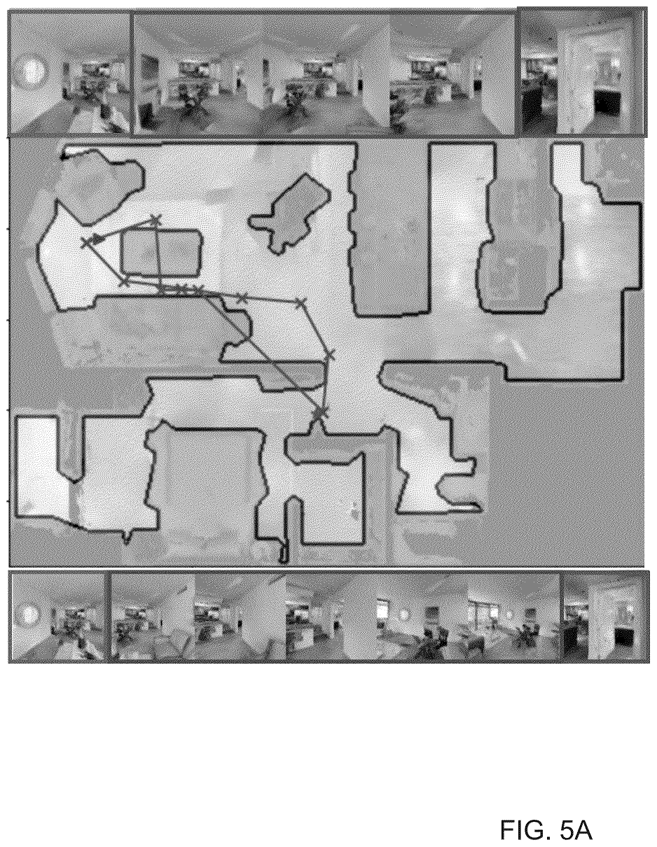

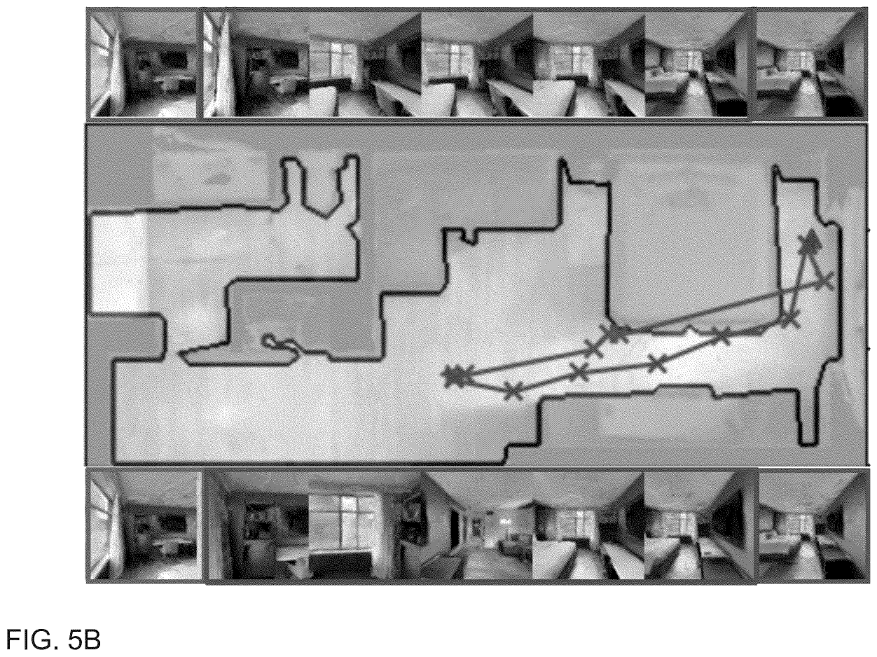

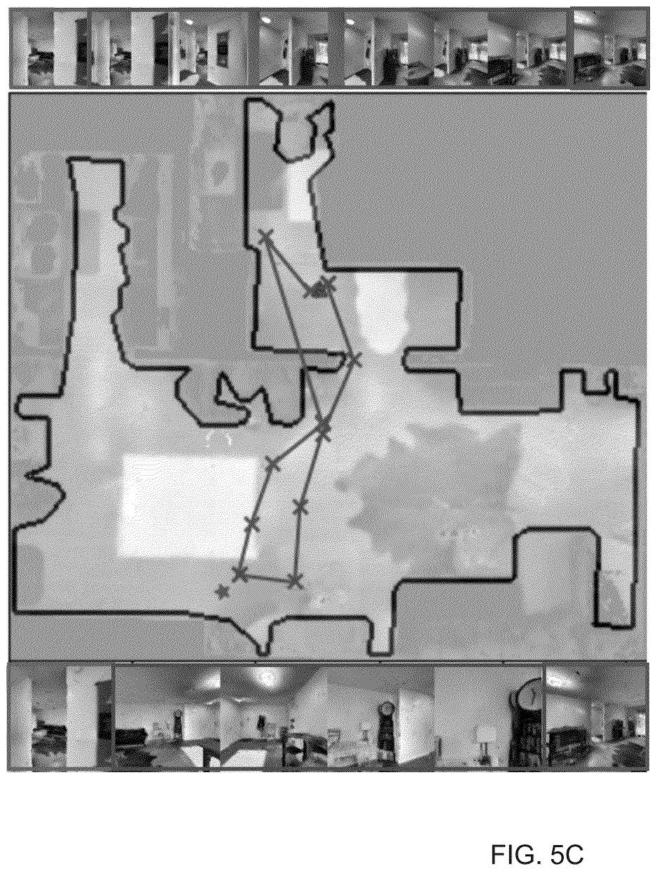

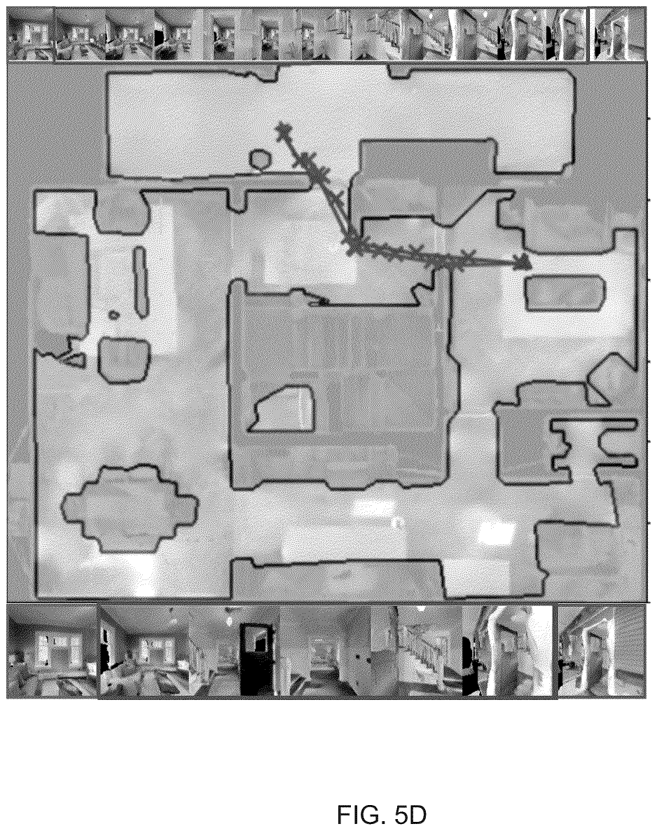

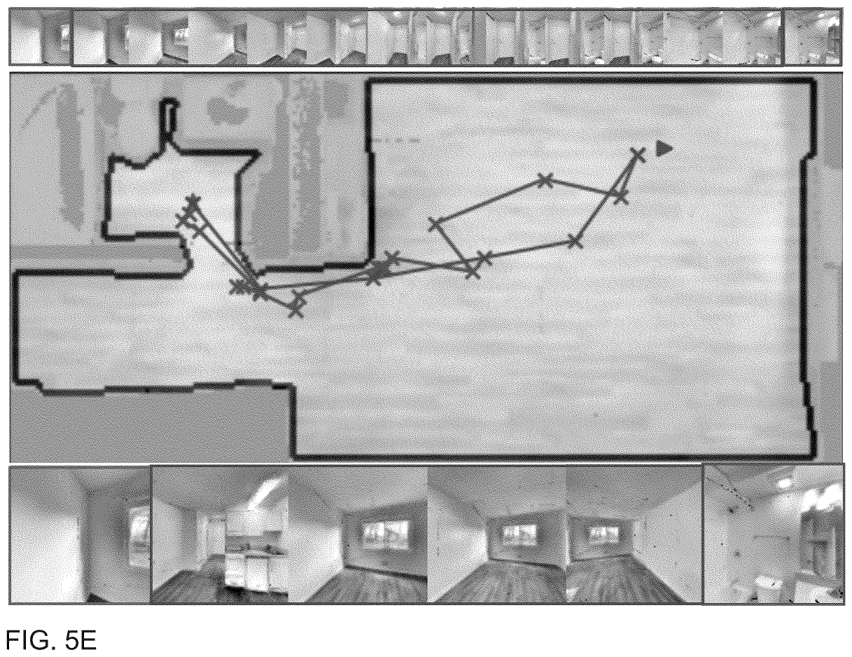

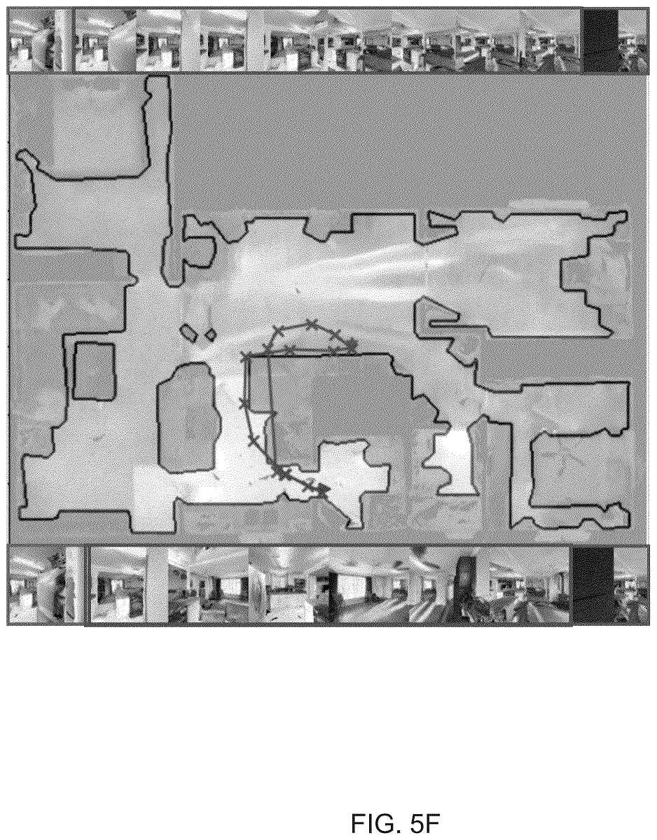

Selecting a path on this semantic graph (DINOv2-Graph) is not necessarily equivalent to a physical path, as illustrated in FIGS. 5A-5F. FIGS. 5A-5F are floorplans depicting examples of shortest paths on DINOv2-Graph (SWG) and on Pose Graph (PS), with corresponding example images. The most similar image

$${r}_{i}^{{x}_{t}}$$

∈ [symbol] to the goal is highlighted in red and localized with a red star on the floorplan, while

$${r}_{i}^{g}$$

∈ [symbol] , in blue, is the most similar image to the current observation. Green crosses connect images along the shortest path in the DINOv2-Graph (corresponding images are highlighted in green on top of the map) and red crosses refer to poses on the Pose Graph (in FIGS. 5B, 5E and 5F corresponding images are highlighted with a purple contour at the bottom of the map).

In example embodiments, the images associated with nodes along the shortest path on the DINOv2-Graph may be used to populate a dynamic context set as candidate intermediate goals (pseudo-waypoints) between the current observation and the goal, thereby providing retrieval-augmented guidance even where the goal is not in view. Accordingly, because the utility of such candidates depends in part on whether connected images are likely to depict overlapping portions of the same scene, example methods may refine the graph to favor edges between images having a high overlap probability, as described below.

In some embodiments, and as further illustrated in FIGS. 5A-5F, the DINOv2-Graph (or other similarity-based graph) is used as a mechanism for identifying candidate context images that may function as intermediate goals (pseudo-waypoints) between a current observation and a goal, rather than as a metric map or path plan that the agent must follow. In particular, the retrieved images associated with nodes along the shortest path in the similarity graph are selected to provide a compact “perceptual bridge” between (i) what the agent currently observes and (ii) what is expected to be observed at or near the goal location, even where the goal is not currently in the agent's field of view.

FIGS. 5A-5F also illustrate that, because the edges of the DINOv2-Graph are defined in a learned feature space (e.g., semantic/appearance similarity), a shortest path on the DINOv2-Graph (shown with green connections and corresponding green-highlighted images) can differ from a shortest path defined in a pose-based or metric space (shown with red connections and corresponding pose-graph markers). This divergence underscores that, in these embodiments, the system does not require pose metadata, explicit localization, or construction of an explicit topological/metric map in order to supply useful intermediate context to a learned navigation policy. In other words, FIGS. 5A-5F illustrate that the DINOv2-Graph is an efficient retrieval structure over previously-collected first-person images that can be used even when stored images are unstructured and/or lack pose annotations.

In such embodiments, the intermediate images selected from the similarity-graph path are not required to be physically adjacent viewpoints, nor required to correspond to a ground-truth traversable route. Instead, the intermediate images are provided to the context-encoding pipeline as candidates that may be informative for navigation. For example, the intermediate images may depict overlapping surroundings, progressively changing viewpoints, or visually salient structures that correlate with progress through the environment. A trained context encoder and/or learned policy may then determine which of the retrieved images (if any) to rely upon at a given time step, and may update that reliance dynamically as the agent's observation changes over time.

In some embodiments, the technical effect of this design is achieved by coupling (i) similarity-graph-based candidate selection with (ii) geometric comparison of each candidate image relative to at least the current observation (and optionally also relative to the goal image), thereby converting the retrieved candidates into context embeddings that carry pose- and/or visibility-related information. As a result, even where the similarity-graph path includes candidates that are not strictly consistent with a metric path, the learned context encoder and/or learned policy can preferentially exploit candidates that are geometrically consistent with the current observation (and optionally the goal) and can reduce or eliminate the influence of candidates that are not useful for progressing toward the goal.

Accordingly, FIGS. 5A-5F also motivate example graph-construction refinements described below, in which edges may be restricted and/or weighted to favor transitions between images having high overlap likelihood in feature space. Such refinements can improve the reliability of pseudo-waypoint candidate selection while retaining the ability to operate without requiring pre-existing maps or pose annotations.

To enforce selection of edges between images that have high overlap probability (that is, represent the same part of the scene), two further modifications were made to the above graph. First, recognizing that a DINOv2 similarity score above th=0.75 between L2 normalized features reflects, in most cases, a good overlap between the two images, only edges were kept for which the similarity was above this threshold, removing all the others. Second, to enforce Dijkstra's algorithm to select paths with high similarity (low cost), the weights wᵢⱼ=\sqrt{(1−sᵢⱼ)}, where sᵢⱼ is the DINOv2 similarity between the L2 normalized features.

During both training and inference, at each steps, the agent finds in [symbol] the most similar images

$${r}_{1}^{{x}_{t}} and {r}_{1}^{g}$$

to the observation xₜ and g, respectively, and computes the shortest path between

$${r}_{1}^{{x}_{t}} and {r}_{1}^{g}$$

on the DINOv2-Graph. Let

$$𝒫 = \{ {r}_{1}^{{x}_{t}} , {r}_{1} , {r}_{2} , … {r}_{n} , {r}_{1}^{g} \}$$

be the set of nodes on the shortest path and C the context size. If n+2>C, images are sampled randomly from [symbol] and all images are updated in the context. If n+2≤C, all images from [symbol] are used to update n+2 images in the context. If no path was found, n=2 and thus only two elements of the context are updated with

$${r}_{1}^{{x}_{t}} and {r}_{1}^{g} .$$

Choice of Graph Structure: Models were trained on the Gibson dataset, where there were around 10 k images per scene in the retrieval dataset [symbol] . The checkpoint obtained at 130M steps was selected for all models. During testing a set of | [symbol] |=1 k images per scene were used.

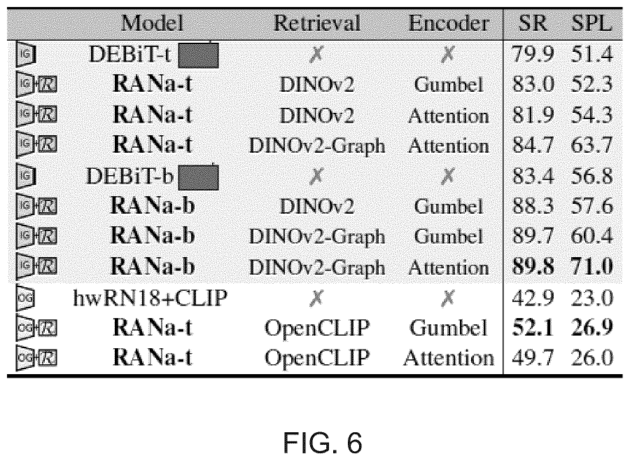

The default model, used for the results shown in FIG. 6, built a weighted graph by removing edges with similarity below th=0.75 and used wᵢⱼ=\sqrt{(1−sᵢⱼ)} as weights. This is referred to as Sparse Weighted Graph (SWG). Three additional approaches were used to the construct the DINOv2-Graph. In one approach, referred to as Sparse Binary Graph, the same graph was considered, but instead of using wᵢⱼ=\sqrt{(1−sᵢⱼ)} as weights wᵢⱼ=1 was used as edge weights. In another approach, Dense Weighted Graph, a similarly threshold th=0.4 was used to yield a much denser graph. In yet another approach, referred to as Pose Graph with PG, these results were compared to a “pose graph,” where instead of DINOv2 features distances between camera poses were used to build the affinity map. Here, a binary graph was considered where edges were cut for which the distance between the camera poses is above 1 m.

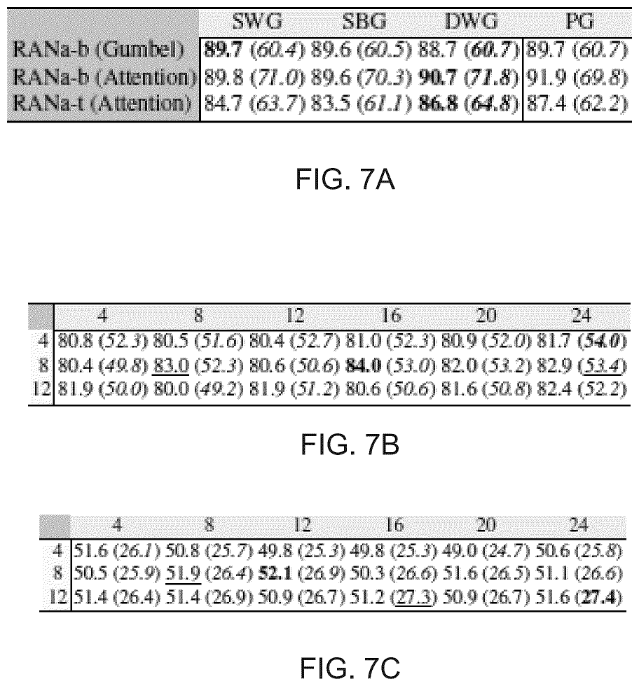

The results shown in FIG. 7A suggest that using a pose aware graph (PG) did not necessarily improve the accuracy over DINOv2-Graph, and when it did, the improvement was quite small. Though the pose of the observation and goal images were not used to select the start and end points of the shortest path,

$${r}_{1}^{{x}_{t}} and {r}_{1}^{g} ,$$

these were retrieved using DINOv2 feature similarity and only DINOv2-Graph was replaced with the Pose Graph. Additionally, it can be seen that the example graph structure did not have a large impact on the model with a Gumbel selector (Gumbel), but had a larger one on the model with attention-based context encoder (Attention), as the Gumbel selector selects an image from the context and uses it independently from other context elements, while Attention combines information from all images within the context and thus it is more significant how the context is filled. It can also be observed that the example Dense Weighted Graph (DWG) performed better than the example Sparse Weighted Graph (SWG). This is believed to be because the model was trained with a dataset [symbol] of size 10 k images and it was rare to have no connection between two requested nodes

$$( {r}_{1}^{{x}_{t}} and {r}_{1}^{g} ) ,$$

which occurred more often at test when only 1 k images were available. Using denser graph such as DWG is believed to help overcome these instances.

Similarities and Differences with Topological Maps: While the example graph representation included some features similar to those of topological map structures, there were significant differences. For example, a topological map was not used to localize the agent, plan, and act to reach a “next waypoint.” Instead, in example methods, the information gathered from planning was passed to the agent as a recommendation in the form of the retrieval context, to be integrated into decision making via learning, as the example agent can be a full-fledged policy that has access to memory, goal, and a series of images along the path. This can enable more informed decision-making, and improved robustness and navigation performance.

Further, an example graph can be connected based only on visual similarity rather than predictions from temporal distances, as visual proximity often provides a proxy for spatial proximity. Among other benefits, this provides the advantage of not needing trajectories to build the graph but instead it can be built from a large number of isolated images.

Metrics: Navigation performance was evaluated by the success rate (SR), which was defined to be the percentage of episodes terminated within a distance of <1 m to the goal after the agent has called the STOP action, and SPL (disclosed in Anderson et al., On Evaluation of Embodied Navigation Agents, arXiv:1807.06757), which was defined as SR weighted by the optimality of the path:

$$SPL = \frac{100}{N} {\sum }_{i = 1}^{N} {S}_{i} \frac{{ℓ}_{i}^{*}}{max ( {ℓ}_{i} , {ℓ}_{i}^{*} )} ,$$

where Sᵢ is a binary success indicator in episode i, [symbol] ᵢ is the agent path length and lᵢ* the shortest path length.

### Effect on Navigation

FIG. 6 shows performance results of the example retrieval-augmented navigation agents (RANa agents) with retrieved context on ImageNav and ObjectNav tasks. To make the baselines comparable, the loaded checkpoints continued training for the same additional 200M training steps updating GRU and policy only. The example RANa agents exhibited significant performance improvements across all settings compared to the DEBiT baseline and the ObjectNav baseline models.

For static context retrieval (both using DINOv2 for ImageNav or OpenCLIP for ObjectNav), the Gumbel encoder provided better results, possibly because there is no inherent ordering in the context and the retrieved features (in the experiments, CroCo-based) contained strong information about the relative pose between context elements and observation. The attention-based encoder performed better for the dynamic graph-based context, where reasoning about the order of context elements becomes important. The graph-based context combined with attention obtained the best results, with a huge boost in SPL (+14.2 and +12.3 points) compared to the DEBiT-b and DEBiT-t baselines, respectively.

For all ObjectNav runs, finetuning x while training on HM3D improved performance, as the visual encoder of DEBiT was only trained on Gibson observations. Additionally, since ImageNav and ObjectNav had different action spaces, the action embedding 1 was learned from scratch.

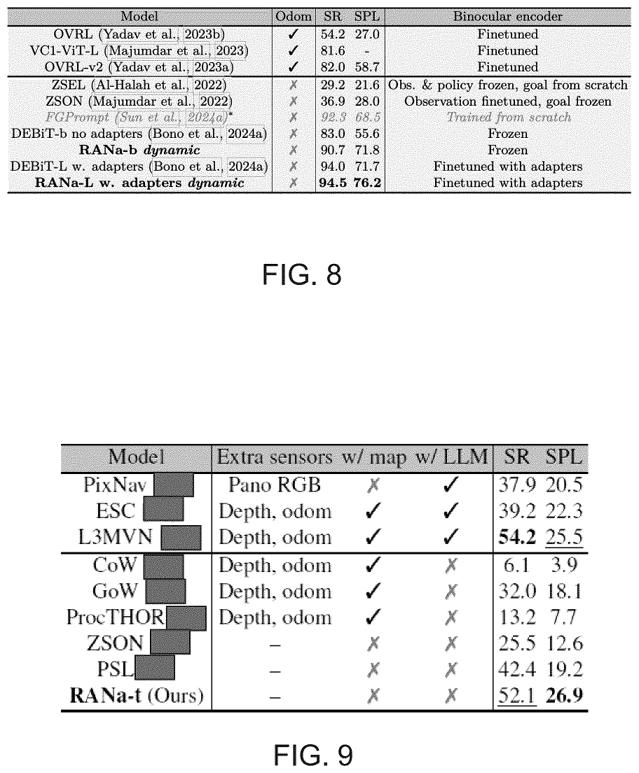

Comparison to ImageNav SOTA: FIG. 8 shows a comparison of RANa for ImageNav with state-of-the-art (SOTA) models that typically finetune (with a navigation loss) visual encoders based on CLIP (Majumdar et al., ZSON: Zero-Shot Object-Goal Navigation using Multimodal Goal Embeddings, In NeurIPS, 2022), CNN (Sun et al., Fgprompt: fine-grained goal prompting for image-goal navigation, In NeurIPS, 2024), ViT (Majumdar et al., Where are we in the search for an artificial visual cortex for embodied intelligence? In arXiv:2303.18240, 2023; Yadav et al., Offline visual representation learning for embodied navigation, In Workshop on Reincarnating Reinforcement Learning at ICLR 2023) and geometric FM (Bono et al., Learning with a Mole: Transferable Latent Spatial Representations for Navigation without Reconstruction, In ICLR, 2024) used for binocular observation-goal comparison. RANa boosted the performance of DEBiT-b, which uses frozen binocular encoders, and achieved performance on par with SOTA methods FGPrompt (Sun et al., 2024) and DEBiT-Large finetuned with adapters (Bono et al., 2024), which use adaptation processes to tune visual encoders to the task. Example RANa methods also achieved strong performance through scalable context encoding and using a (here, generic frozen) visual FM, enabling several zero-shot tasks. As illustrated in the last row of this table in FIG. 8, the largest RANa method tested (RANa-L) finetuned with adapters achieved the best performance.

Comparison to ObjectNav SOTA. FIG. 9 compares results of RANa-t (tiny model) for ObjectNav with competing approaches. Compared to methods of similar sensor settings (one FPV RGB camera), RANa-t outperformed the previous SOTA by +9.7 on SR and +7.7 on SPL.

Neither ZSON (Majumdar et al., ZSON: Zero-Shot Object-Goal Navigation using Multimodal Goal Embeddings. In NeurIPS, 2022) nor PSL (Sun et al., Prioritized semantic learning for zero-shot instance navigation, arXiv preprint arXiv:2403.11650, 2024) were trained on ObjectNav episodes, but instead were trained on HM3D ImageNav episodes, which may have provided a (small) advantage to RANa. Accordingly, additional experiments compared RANa-t to competing methods that use extra sensors, such as depth camera, GPS+compass, or six camera sensors, as well as LLM-guided navigation. Here, RANa-t still provided competitive results, outperforming several strong methods such as ESC (Zhou et al., Esc: Exploration with soft commonsense constraints for zero-shot object navigation, In ICLR, pages 42829-42842. PMLR, 2023) and PixNav (Cai et al., Bridging zero-shot object navigation and foundation models through pixel-guided navigation skill. In ICRA, pages 5228-5234, IEEE, 2024). Compared to L3MVN (Yu et al., L3mvn: Leveraging large language models for visual target navigation, in IROS, pages 3554-3560. IEEE, 2023), which leverages depth and pose to construct a semantic map and uses GPT-2 to guide exploration via object searching, RANa-t was competitive, being −2.1 below on SR but +1.4 above on SPL, meaning that the retrieved context guided the agent for RANa-t to more efficient routes to an object goal.

### Retrieval Efficiency

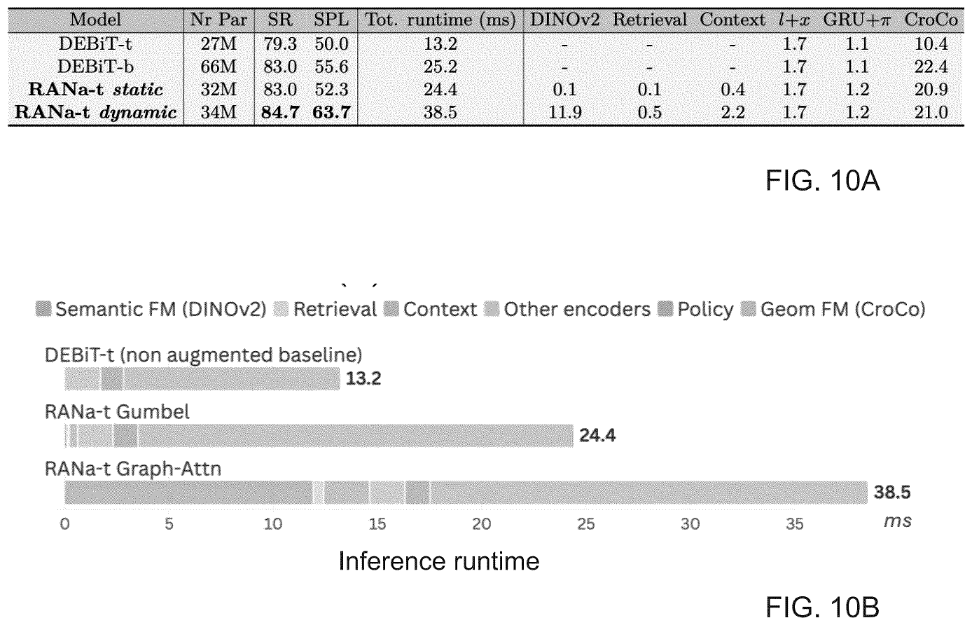

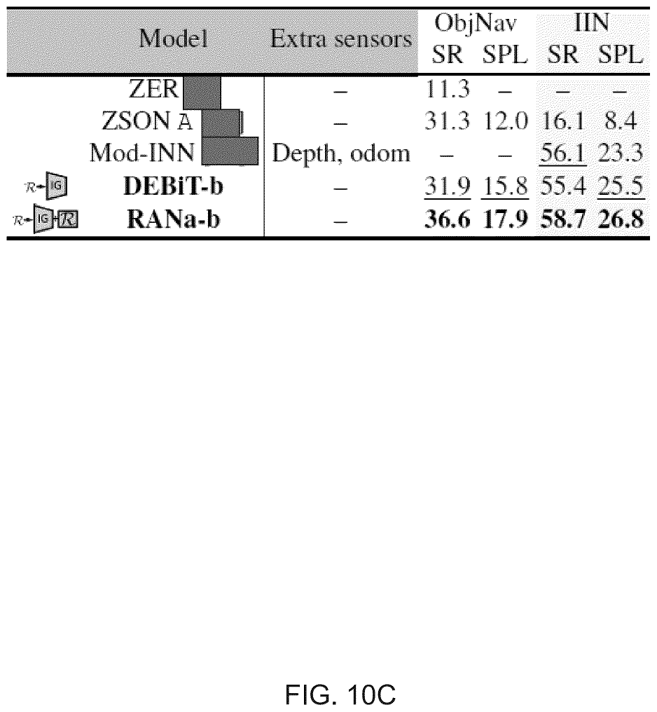

To evaluate inference efficiency, FIG. 10A shows model sizes and results of an analysis of inference runtimes (in ms) of various components of example DEBiT and RANa models. The runtimes were timed on one Nvidia H100-80G GPU. Most of the runtimes were spent on image feature comparisons (DINOv2, CroCo), which increase with retrieval because of additional operations needed to select and compare retrieved elements. Retrieval time was negligible, and scaled favorably with the dataset size due to efficient approximate nearest neighbor (ANN) search libraries such as Faiss (e.g., as disclosed in Douze et al, The Faiss Library, arXiv:2401.08281, 2024). Inference time was slightly higher for RANa because the encoder c computed CroCo features between context images and observation and goal, while DEBiT only ran CroCo between observation and goal. RANa-t runtime was still smaller than and faster than DEBiT-b while achieving similar performance.

FIG. 10B shows inference runtimes for example methods RANa-t Gumbel and RANa-t Graph-Attn compared to a non-augmented baseline (DEBiT-t), including runtimes for a semantic FM (DINOv2), retrieval, context, other encoders, policy, and an example geometric FM (Croco). As shown, the retrieval operation itself may be implemented using efficient (approximate) nearest-neighbor search and can be negligible compared to the compute consumed by running semantic and geometric vision models and the navigation policy, even when dynamic context is used. FIG. 10B further illustrates that, in the example implementation, retrieval contributes a negligible portion of overall inference runtime relative to the other model computations, thereby enabling retrieval augmentation without materially increasing end-to-end inference latency (e.g., due to efficient nearest-neighbor/approximate nearest-neighbor search over the image database). Including dynamic context added to the compute time needed to run DINOv2 on each observation, but its overall runtime remained comparable to that of other agents.

The results demonstrate that retrieval augmentation can be a more frugal alternative to model scaling. Retrieval is efficient, and negligible compared to other computation time spent by an agent (e.g., with vision models). Overall inference runtime can be comparable to non-augmented architectures such as DEBiT.

### Zero-Shot Generalization

By retrieving the image goal [symbol] from the database, it is possible to apply any ImageNav model to the ObjectNav and Instance-ImageNav tasks. FIG. 10C compares the performance of example zero-shot ImageNav architectures in: (i) Gibson ObjectNav, a variant introduced in AI-Halah et al., Zero experience required: Plug & play modular transfer learning for semantic visual navigation, In CVPR, pages 17031-17041, 2022, for ImageNav agents including 1,000 episodes over five Gibson scenes and containing the six object categories of HM3D ObjectNav; and (ii) HM3D Instance-ImageNav with modified camera intrinsics and robot size to fit the ImageNav configuration. In both cases retrieval databases of 50,000 images were used to retrieve an image goal [symbol] as close as possible to the goal. In Instance-ImageNav, the image goal was replaced with the closest image in DINOv2 feature space from the retrieval set. In zero-shot ObjectNav the top-9 closest images in CLIP space were retrieved and were re-ranked at each step to select as goal [symbol] the element with the highest co-visibility with the current observation, and the remaining eight images constituted the context. This was done using the frozen co-visibility auxiliary loss head used to train DEBiT models. This step is useful since in ObjectNav any instance of a target object is a valid goal.

Incorporating retrieval allows the use of DEBiT-b for both tasks in the example methods to achieve strong performance in line with best existing methods. For comparison, DEBiT-b achieved 10 SR and 3.1 SPL on the original Instance-ImageNav task. RANa outperformed the feature-matching based method (Krantz et al., Navigating to objects specified by images, In CVPR, 2023), which used additional depth and odometry sensors and was the current SOTA in zero-shot Instance-ImageNav, as well as ZSON (configuration A) (Majumdar et al., ZSON: Zero-Shot Object-Goal Navigation using Multimodal Goal Embeddings, In NeurIPS, 2022) in zero-shot Gibson ObjectNav.

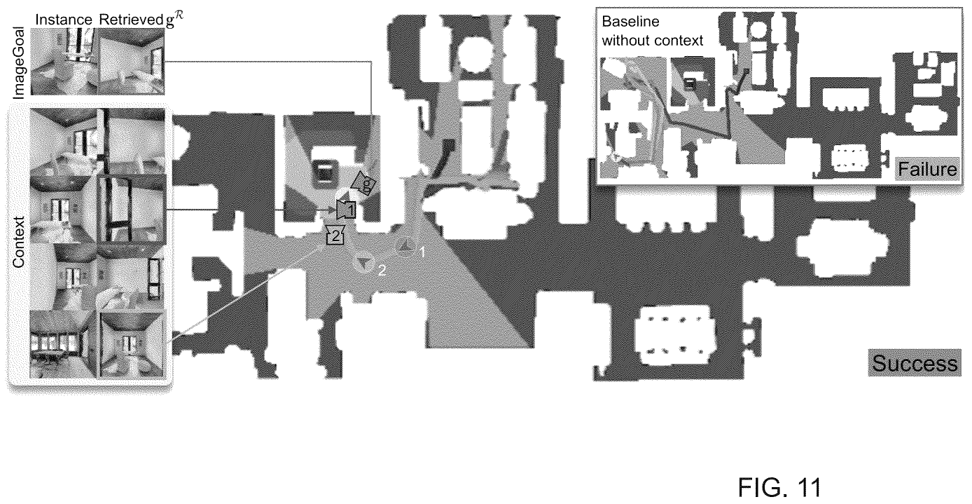

FIG. 11 shows an example of successful zero-shot Instance-ImageNav, where the example RANa agent first correctly picked from the context the door near the goal (1), and then a view of the room where the target is (2), leading to success. In contrast, the DEBiT-b baseline without context did not see the target inside the room and passes by, exploring the wrong side of the house and failing to complete the episode, as shown in the inlet image in FIG. 11.

### Evaluation in Physical Environment

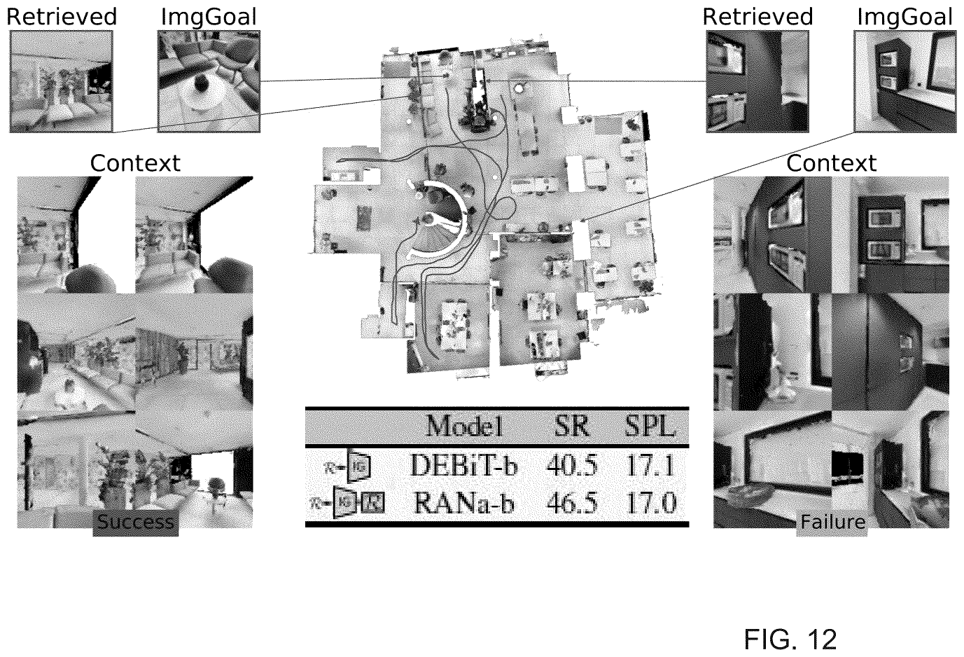

The example RANa-b agent (ImageNav agent, augmented with retrieved goal and retrieved context) was trained on a small Instance-ImageNav dataset of 200 episodes where goal images were pictures taken in an actual (office) environment. The positions of twenty real images were manually annotated in a simulated 3D reconstruction of the environment. A retrieval set of 10,000 images was generated from uniformly-sampled navigable poses, rendered in simulation using the agent configuration. Simulating navigation from ten random starting poses towards each of the twenty real image goals, RANa reached 46.5 success, vs. 40.5 of DEBiT-b, as shown in FIG. 12, inlet Table.

FIG. 12 illustrates two episodes including a challenging success case (left), where the cactus viewing angle is far from any view the agent could capture, and (right) a failure case, where the retrieval returned as goal [symbol] an image of a different instance of the same microwave model at a different position. Some retrieved context images depicted the correct goal, and RANa appeared to be able to exploit this information as it succeeded in 3/10 episodes featuring this goal.

### Ablation Experiments

All ablations were conducted on RANa-t models based on the DEBiT-t backbone to allow for faster training and evaluation. The geometric FM features for retrieval may be configured to optimize the effectiveness of example retrieval-augmented navigation methods. This was considered for RANa by training with the same procedure as all other models a RANa-t ImageNav network where the binocular encoders d in Equation (6) above were replaced by a hwRN18 (same as encoder x) that takes as 9×112×112 input the channel-concatenated observation, goal and context, and outputs the context features e_{t,n} that were fed to the Gumbel selector.

This example model achieved 79.1 SR and 48.2 SPL in ImageNav (against 83.0 SR and 52.3 SPL of RANa-t). In this setting, the agent was not capable of exploiting context, demonstrating the improved effectiveness of geometric pre-training performed with the geometric FM in example methods, e.g., based on the binocular encoders disclosed in Bono et al., End-to-End (Instance)-Image Goal Navigation through Correspondence as an Emergent Phenomenon, In ICLR, 2024.

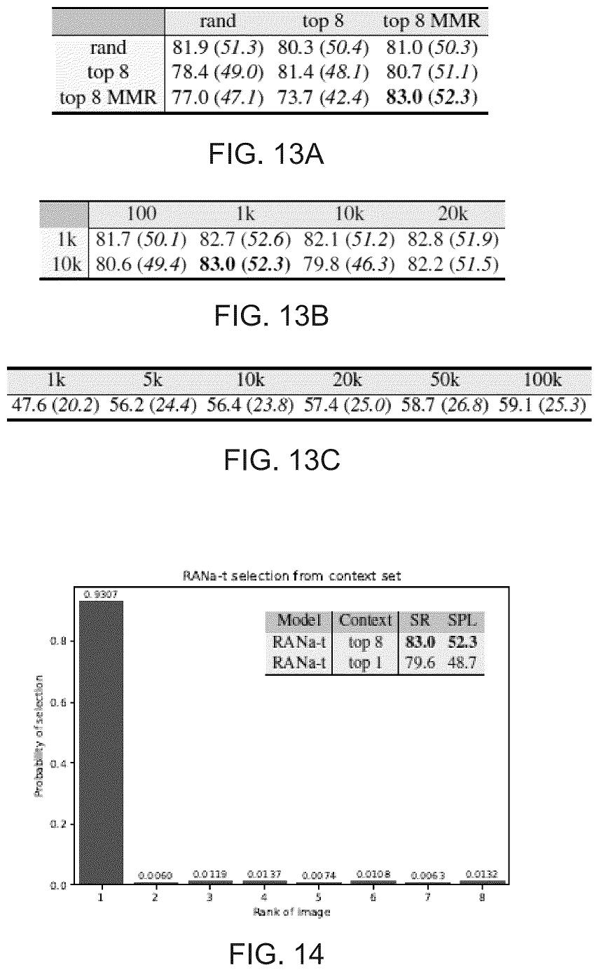

For evaluating context building, FIG. 13A illustrates the behavior of the example RANa-t ImageNav model when using different example strategies to create the context, (i) rand: 8 random elements from the retrieval dataset, (ii) top 8: most similar database images to the goal in DINOv2 feature space, and (iii) top 8 MMR: most similar database images filtered by MMR as disclosed above. Filtering the context with MMR can be useful, but the agent relies on diverse context items (e.g., in experiments, removing MMR degraded performance). Other approaches had lower but more constant performance across settings.

Retrieval dataset size was analyzed, with results shown in FIG. 13B. The results demonstrate that the number of images in the retrieval database does not need to be large, e.g., 100 may be sufficient for Gibson scenes that are relatively small. More images may be useful for zero-shot cases where the goal image g is retrieved from the database, and thus accuracy is crucial for success. FIG. 13C demonstrates that zero-shot Instance-ImageNav performance increases with retrieval dataset size.

Additional ablation experiments were conducted using RANa-t models with Gumbel selector as context encoder c. FIGS. 7B and 7C illustrate an impact of context size for ImageNav and ObjectNav, respectively, with retrieval over different context sizes and combinations of train and test conditions.

An advantage of the example Gumbel selector is that it allows for context of different sizes during evaluation, independent of the context size used during training. In the experiments, this parameter had a relatively minor impact on performance, with larger training context sizes showing positive performance trends. The example size N=8 worked well both for ImageNav and ObjectNav and balanced navigation performance with execution time. For ObjectNav, a more pronounced performance increase was observed for larger context sizes during evaluation, so experimental methods used N=8 during training and N=12 during evaluation.

An analysis of context elements for ImageNav demonstrated that 93.07% of the time RANa-t selected the first element retrieved in the context, as shown in FIG. 14. This is because the embeddings {e_{t,n}}_{n=1 . . . N} used to estimate the relevance of the corresponding context element was the concatenation of the Geometric FM model d comparing context images to the observation and the goal. Since the context elements were typically close to the goal, but not necessarily to the observation, the first context element, the most similar to the goal, arose as the most relevant one most of the time, such as when context elements were not visible from the current agent pose.

To further evaluate the benefit of the remaining context elements, additional experiments evaluated the RANa-t model using one single context element, top 1, which was always the most similar image to the goal in DINOv2 feature space. Performance for this model, compared to RANa-t with N=8 context elements (top 8) is shown in the inlet table in FIG. 14. FIG. 14 shows a histogram of the rank of the context element selected by RANa-t with Gumbel context encoder on the ImageNav Gibson evaluation set. In the top 1 setting, performance of RANa-t decreased to levels slightly worse than the baseline model without context. This demonstrates that the additional context elements provided significant situational information that RANa was capable of exploiting to improve navigation performance.

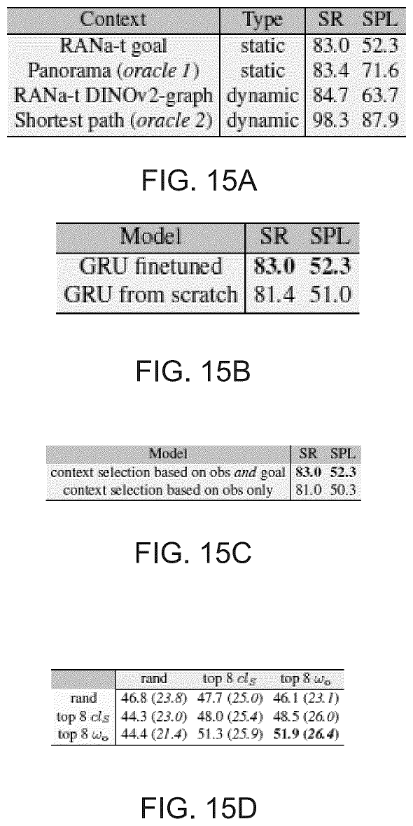

Results of an analysis of “oracle” context for ImageNav is shown in FIG. 15A. FIG. 15A illustrates navigation with “oracle” context, where SR (SPL) for ImageNav used privileged information to build oracle context. Experiments assessed which information was most useful and could be exploited by RANa,by building contexts using privileged information in simulation, and thus in these experiments the retrieval dataset D was not used.

Oracle 1 captured a panoramic view of the goal location and was created by collecting N=8 context images at the goal position while rotating the camera view by 45° clockwise for each element. This context represented a soft upper bound for an example static context, where a fixed set of items is chosen per episode based on their similarity with the goal image. Oracle 2 context was richer, and it was generated by computing the shortest path from the agent position to the goal at each step and collecting views along this path. This provided a soft upper bound for the DINOv2-Graph context described above, which was dynamically generated at each step on the context graph. FIG. 15A demonstrates that both types of oracle context can provide large gains, most significantly in SPL, i.e., navigation efficiency. This suggests that there may not be as much improvement in success (SR) using static goal context, while more structured information, e.g., paths, derived from data in the dataset D can improve navigation considerable.

Impact of Pre-trained GRU Weights: All example RANa agents in the experiments used a GRU finetuned from the baseline agent's GRU. The impact of this feature was evaluated for the ImageNav model by training the RANa-t GRU from scratch while keeping all other settings fixed. FIG. 15B shows an impact of GRU finetuning, with SR (SPL) form ImageNav with GRU finetuned and trained from scratch. FIG. 15B demonstrates that finetuning from pretrained weights (here, those of DEBiT) improved navigation performance. Faster convergence during training was also observed.

Context Selection Criteria: While in RANa ObjectNav the context selection was based on the observation, as the goal image was not available, in RANa ImageNav both observation and goal images were available. In experiments a feature vector was used for each context element that was obtained by concatenating two features: the output of the Geometric FM d comparing context element and observation; and the output of d comparing context element and goal. The impact of this choice was evaluated by training a RANa-t model that selects context elements based only on the first feature above, comparing context elements to the observation. The performance of this variant, compared to the baseline that uses both observation and goal, is shown in FIG. 15C. This figure shows the impact of context selection in SR (SPL) for ImageNav with context elements selected based on comparisons with only the observation, or both goal and observation. FIG. 15C shows that information provided by comparing the context to the goal is useful and can be exploited by the example RANa model to navigate more successfully and efficiently to the goa.

Context building for ObjectNav: FIG. 15D shows impact of retrieval data selection, in SR (SPL) for ObjectNav and with different context building strategies, combinations of training and test conditions. FIG. 15D shows the behavior of RANa-t ObjectNav when adopting different context building approaches: i) rand: eight random elements from the retrieval dataset; ii) top 8 clₛ: most similar database images to the object goal encoder in CLIP feature space using CLIP similarity as metric; and iii) top 8 ωₒ: most similar database images using the score softmax normalization described in Eq. (9).

The observed behavior was similar to ImageNav described above. First, a RANa-t model trained with a context with randomly selected images from the scene gallery performed worse than a model trained with either top 8 images. Still, however, this model outperformed the baseline trained without retrieval (SR=42.9 and SPL=23.0 for the non-retrieval baseline) and was more robust to random context images during evaluation. For RANa-t models trained with retrieval top 8 context, improved performance from using softmax normalized scores was observed.

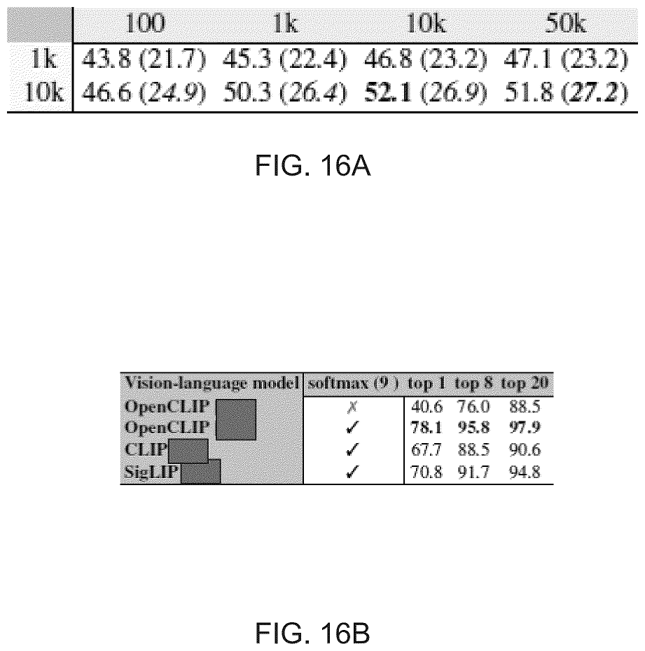

Impact of Retrieval Dataset Size for ObjectNav: FIG. 16A shows impact of database size in SR (SPL) for ObjectNav and with different database sizes, combinations of training and test conditions. The results demonstrate that unlike with ImageNav, ObjectNav benefitted from larger retrieval datasets both at training and at testing, with performance degrading with a training dataset with only 1,000 images. At testing, using larger retrieval datasets led to better performance, with metrics degrading with a dataset containing only 100 items.

Impact of CLIP Variants for ObjectNav: Additional experiments built retrieval datasets of size 10 k images for each of the 100 HM3DSem-v0.2 scenes used for ObjectNav (80 training, 20 test). For each of the six target object categories (chair, bed, plant, toilet, tv monitor, sofa) and for each scene, a search was performed in the retrieval dataset D by querying the CLIP-encoded goal category (that is, the CLIP text encoder for the sentence “a picture of a (category) inside a house”) and comparing it with CLIP encoded dataset images of the scene, providing top 1, top 8, and top 20 success percentages. A retrieval was considered successful if the retrieved image (whose ground-truth pose was known) was closer to one of the viewpoints of an object instance of the correct category than the success threshold of the ObjectNav task (here, 1 m).

FIG. 16B shows evaluation results. The figure shows that OpenCLIP performed better than alternative CLIP models, namely OpenAI's original CLIP weights (Radford et al., Learning transferable visual models from natural language supervision, In ICML, 2021) and SigLIP (Zhai et al., Sigmoid Loss for Language Image Pre-Training, In ICCV, 2023), all with the example softmax normalization shown in Eq. (9) being used. Since the number of target classes was known (six in the experiments), rescaling the score of each image in the dataset [symbol] via softmax significantly boosted performance compared to ranking images by CLIP similarity to the category.

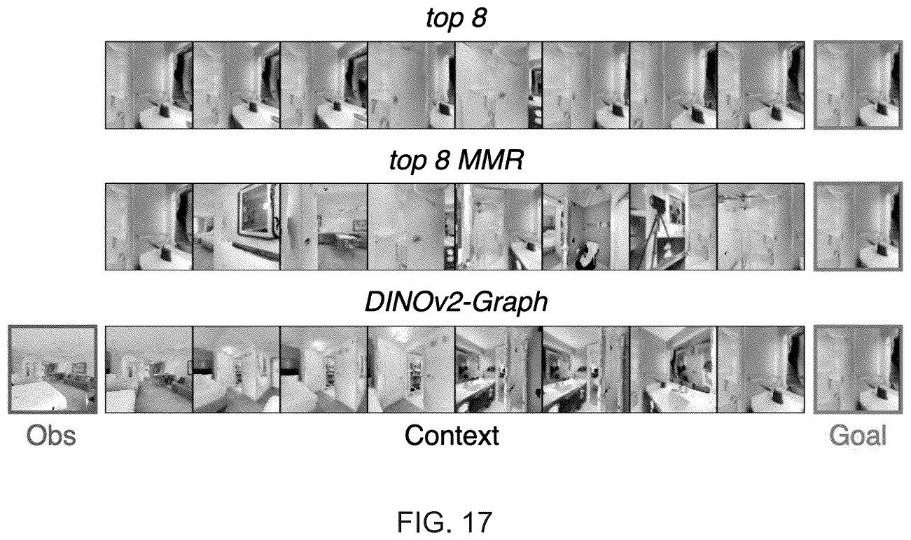

Examples of Retrieved Context: FIG. 17 shows three example types of context for RANa ImageNav in experiments, for N=8: top 8 most similar dataset images to the image goal in DINOv2 feature space (top) and top 8 MMR most similar images filtered by Maximum Margin Relevance (MMR) (middle) are static context types; that is, they are fixed along one episode and depend only on the goal image, shown on the right. DINOv2—Graph (bottom) is a dynamic context that is recalculated at each step and depends on the observation (left) as well.

The results show that the most similar images to the goal were very similar to each other as well, and thus might not be as useful to an example RANa agent. Filtering images using MMR increased the diversity of the context items, which increased RANa performance, as illustrated above. For navigation purposes, the DINOv2-Graph context appeared to be the most informative, as it provided waypoints from the current location to the goal, and this context provided the best navigation performance in the experiments for RANa, as shown in FIG. 6.

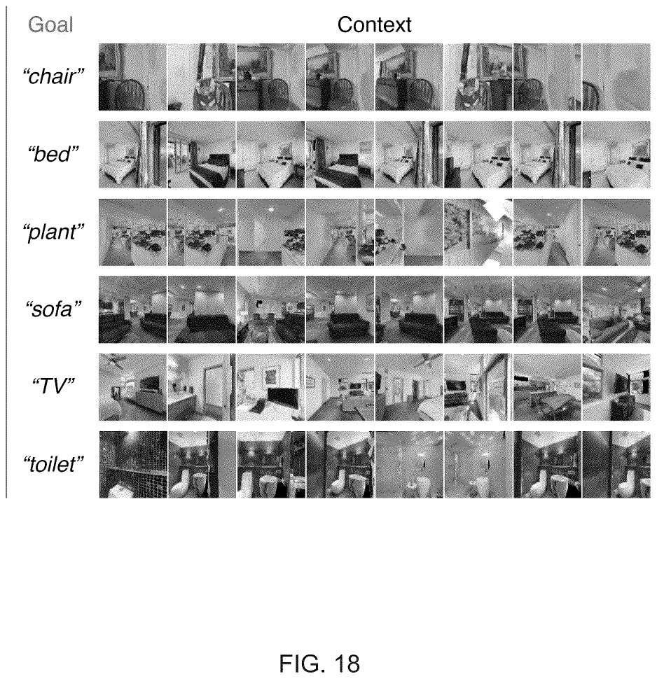

FIG. 18 depicts examples of context for RANa ObjectNav using similarity in CLIP feature space for the six example goal categories: chair, bed, plant, sofa, tv monitor, and toilet. The results accurately represented instances of the target object present in the scene, though in the tv monitor class some errors were observed, e.g., in scenes where monitors were absent.

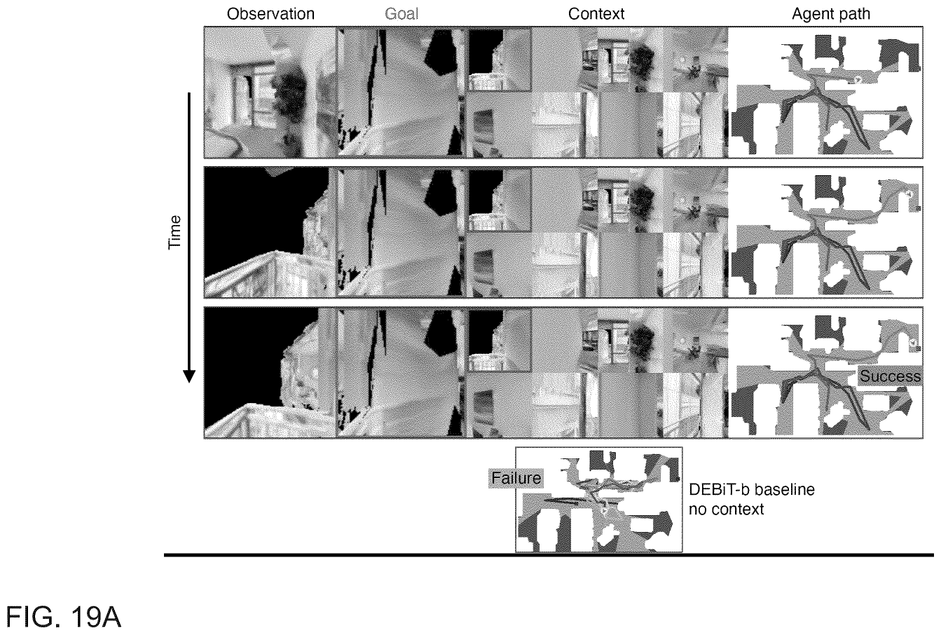

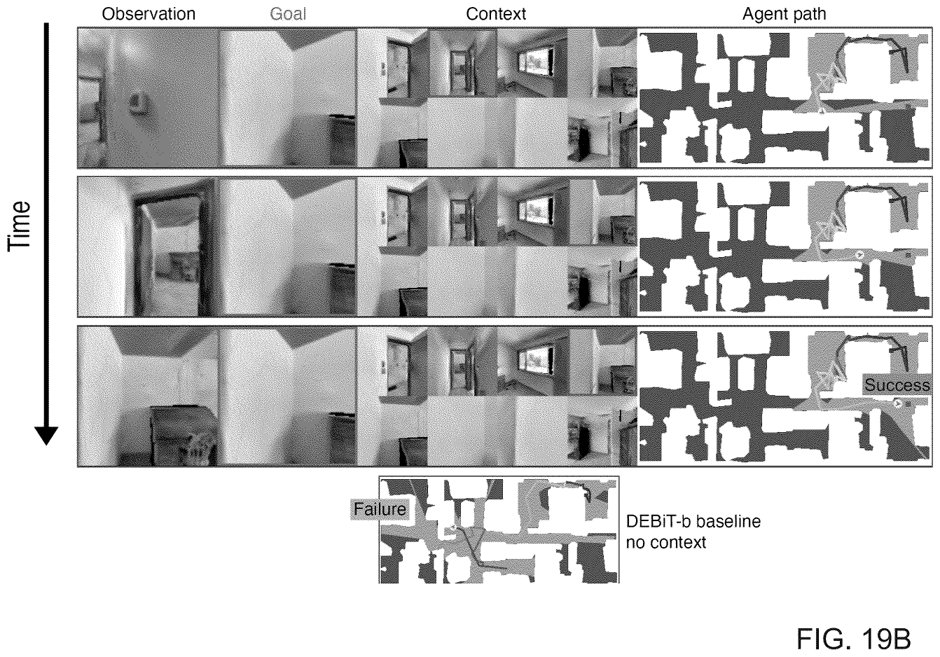

Navigation Examples: FIGS. 19A-19B illustrate examples of the agent RANa-b navigating to two challenging ImageNav goals, respectively. The figures visualize the observation (left), goal (highlighted in green), N=8 context elements, with the one selected at the given time step highlighted in red, and the agent path drawn on the scene floorplan on the right. Each row of pictures focuses on one time step along the episode and are ordered in time from top to bottom, In FIGS. 19A-19B, time was not sampled uniformly. Instead, time steps were selected, typically toward the end of the episode, where the agent makes particularly significant context selections to solve the episode.

The episode illustrated in FIG. 19A is challenging because the environment is complex, the goal image is ambiguous, and it is “hidden” in a terrace at the extreme periphery of the navigable space. The baseline DEBiT-b agent, without context, does its best to explore the environment (apartment) and gets close to the terrace door where the goal is located, but does not succeed in navigating to it. RANa-b selects from the context an image (highlighted in red) that contains the railing of the terrace that helps the example agent solve this complex navigation episode. The navigation episode in FIG. 19B is complex for similar reasons: a large complex environment and a goal image with very little information. RANa was capable of exploiting the few relevant context items, by first selecting the context image containing the door to the room where the goal is located, and then the cabinet, whose corner is visible on the goal image.

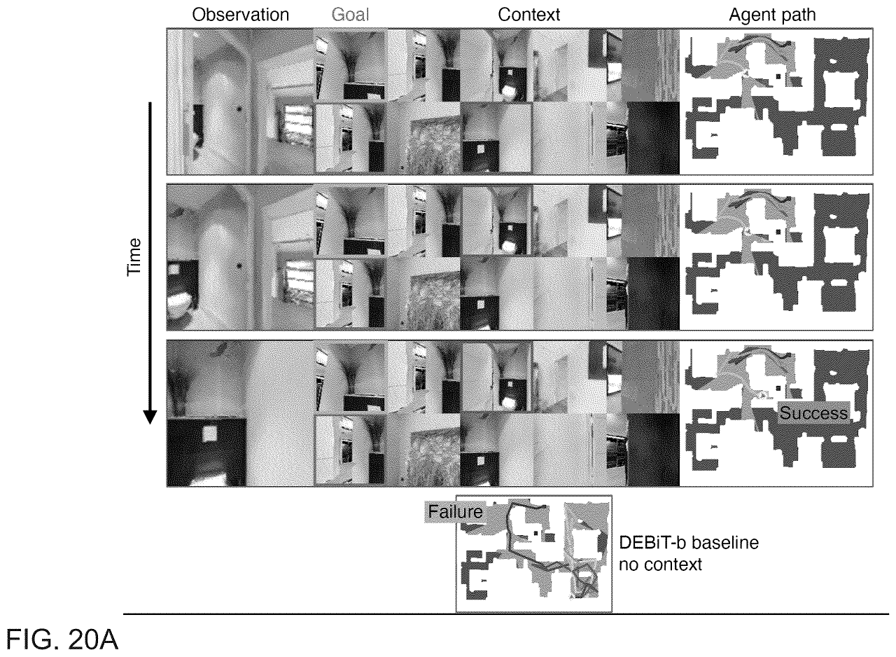

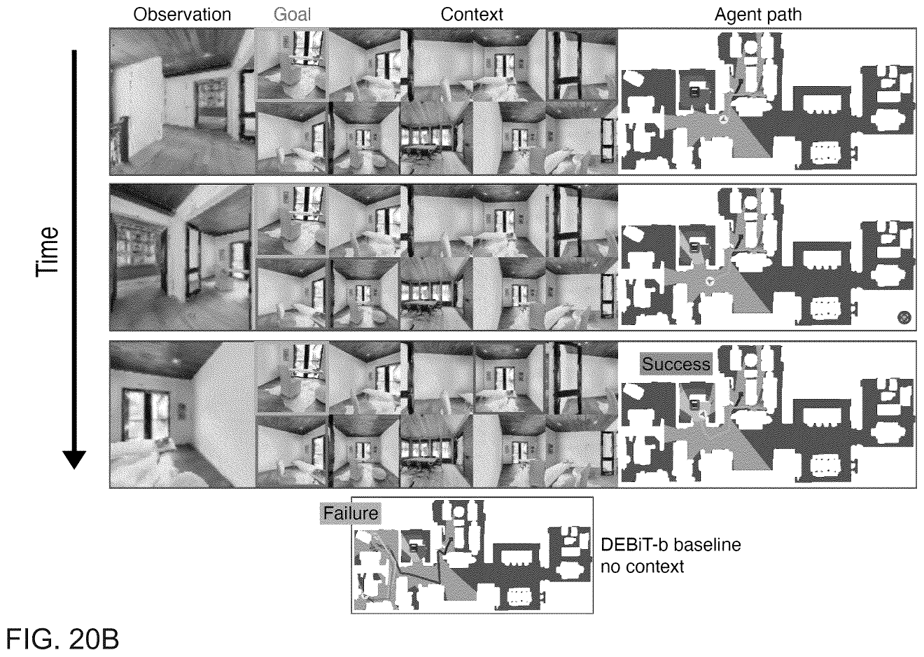

FIGS. 20A-20B show an example in which RANa-b successfully navigated to example goals in two zero-shot Instance-ImageNav episodes. Results are visualized in the same way as in FIGS. 19A-19B, with the exception of the goal image. In this example there are two goal images, one from the original task (highlighted in cyan) which is taken with a sensor with different pose and intrinsics of the agent sensor, and the goal image [symbol] , highlighted in green, which is retrieved from the scene database [symbol] . The agent observation is on the left, next to it is the goal image highlighted in green, and then there are N=8 context elements, with the one selected by the RANa agent at the current time step highlighted in red, and on the right the agent path drawn on the floorplan of the scene, with the goal position indicated by a red square. The bottom shows the trajectory of the baseline DEBiT-b agent on the same episode.

In both cases, RANa selected context items that represented elements visible in the agent observation (the toilet on the left and the door on the right) that guide the agent inside the room where the goal is located. In both cases, the baseline agent, lacking this context, passed along the same path, but did not enter the room.

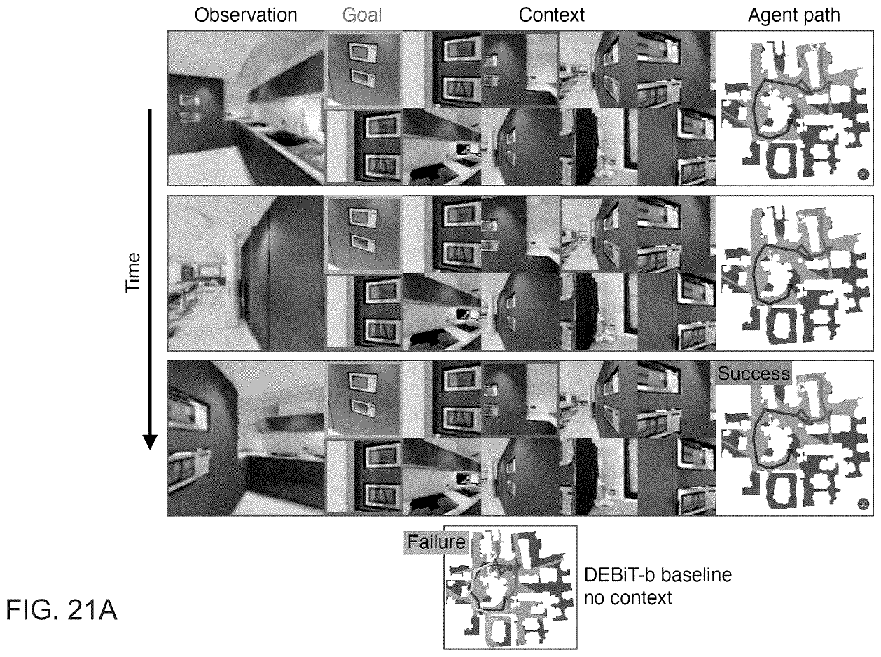

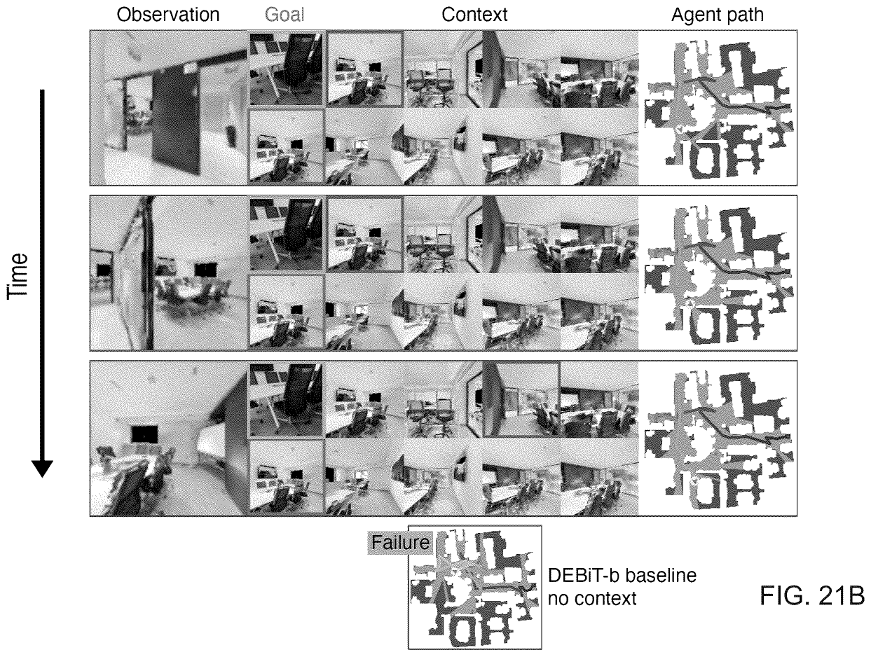

FIGS. 21A-21B illustrate an even more challenging scenario, where RANa navigates in two zero-shot Instance-ImageNav episodes, where the goal image is captured with a smartphone in a real environment. In this experiment, there was access to the environment and a 3D model of the scene was available. The agent navigated to the retrieved goal image [symbol] from the database [symbol] in the simulated reconstruction of the scene. The example in FIG. 21A is notable in that the retrieved goal image, in green, is not the correct instance of the original goal. However, guided by several context items that contained instances of the original goal image, RANa succeeded in reaching the goal. In the navigation episode in FIG. 21B, the example agent selected relevant context elements containing the chairs of the meeting room where the goal was positioned, and it entered the room, solving the navigation episode.

The experiments demonstrate that a general retrieval-augmented navigation agent, trained with RL according to example methods and systems is able to retrieve and act on images stored in a large, global database of robot observations. Example methods can exploit pre-trained foundation models to allow the agent to query and process contextual information that can be useful for solving its target task. Augmenting ImageNav and ObjectNav agents with a context retrieval module was shown to improve navigation performance in both tasks, despite the goal specifications by different modalities (an image in ImageNav, text ObjectNav), which demonstrates the generality of example methods. Moreover, example retrieval-augmented navigation agents can use retrieval across domains and modalities to apply existing agents to new tasks in a zero-shot fashion. Example retrieval-augmented navigation agent navigation agents can benefit from, as a nonlimiting example, the large amount of unstructured data collected during the operation of robot fleets.

### Applications

Example applications include autonomous agents for performing various navigation tasks such as, but not limited to, guiding customers in locations such as shopping centers, museums, hospitals, offices, event locations, etc., delivering parcels, moving through factories, laboratories, plants, or warehouses, or others. Example systems and methods can provide improvement in navigation capabilities of autonomous agents.

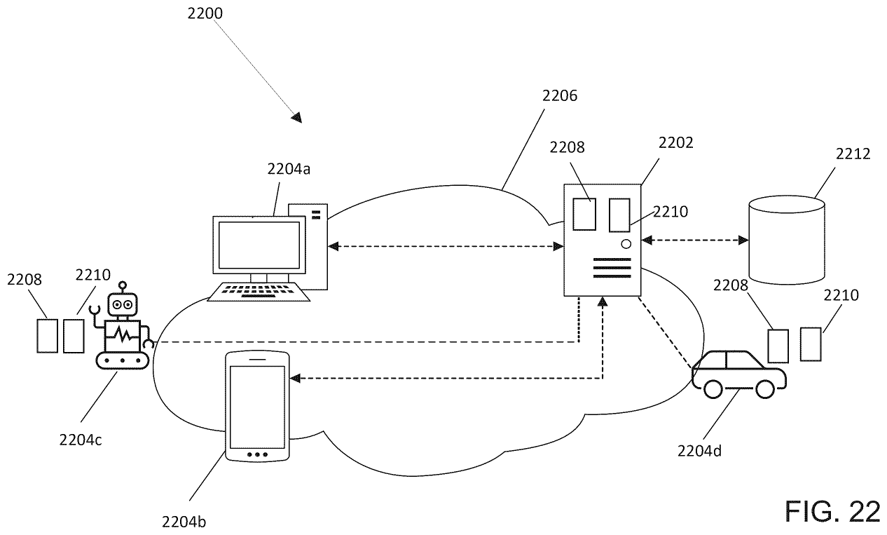

Example systems, methods, and embodiments may be implemented within an architecture 2200 or a portion thereof such as illustrated in FIG. 22. The example architecture 2200 may include a server 2202 and/or one or more devices such as devices 2204. The devices 2204 may operate as client devices and may communicate over a network 2206 which may be wireless and/or wired, such as the Internet, for data exchange, or may operate as standalone devices (or even disconnected from the server 2202 entirely).

The server 2202 and the devices 2204 can each include a processor, e.g., processor 2208, and a memory, e.g., memory, such as but not limited to random-access memory (RAM), read-only memory (ROM), hard disks, solid state disks, or other non-volatile storage media. Memory 2210 may also be provided in whole or in part by external storage in communication with the processor 2208.

The retrieval-augmented navigation system 100, 400, 2300 (described below), for instance, may be provided in the server 2202 and/or in one or more of the devices 2204. In some example embodiments, the retrieval-augmented navigation system 100, 400, 2300 is provided in the devices 2204, possibly without the training module 130, and the training module 130 is provided in the devices 2204 and/or the server 2202. In other example embodiments, the server 2202 trains the retrieval-augmented navigation system 100, 400, 2300 offline, online, or a combination of offline and online, and the retrieval-augmented navigation system is then provided in the devices. One or more portions of the retrieval-augmented navigation system may be pretrained, as explained above.

It will be appreciated that the processor 2208 in the server 2202 or devices 2204 can include either a single processor or multiple processors operating in series or in parallel, and that the memory 2210 in the server or the devices can include one or more memories, including combinations of memory types and/or locations. References to a processor herein can refer to one or more processors, and references to memory or storage can refer to one or more memory devices or storage devices. Server 2202 may also include, but are not limited to, dedicated servers, cloud-based servers, or a combination (e.g., shared). Storage, e.g., a database, may be embodied in suitable storage in the server 2202, device 2204, a connected remote storage 2212 (shown in connection with the server 2202, but can likewise be connected to client devices), or any combination.

Devices 2204 may be any processor-based device, terminal, etc., and/or may be embodied in an application executable by a processor-based device, etc. Example devices include, but are not limited to, autonomous devices, such as robots. Devices 2204 may operate as clients and be disposed within the server 2202 and/or external to the server (local or remote, or any combination) and in communication with the server, or may operate as standalone devices, or a combination.

Example devices 2204 include, but are not limited to, autonomous computers 2204a, mobile communication devices (e.g., smartphones, tablet computers, etc.) 2204b, robots 2204c (including but not limited to terrestrial robots), autonomous vehicles 2204d, wearable devices, virtual reality, augmented reality, or mixed reality devices (not shown), or others, or portions thereof. Devices 2204 communicating with the server 2202 may be configured for sending data to and/or receiving data from the server. Devices may include, but need not include, one or more input devices, such as image capturing devices, and/or output devices, such as for communicating, e.g., transmitting, actions determined through navigation methods. Devices may include combinations of client devices.

In example training methods, the server 2202 or devices 2204 may receive a dataset from any suitable source, e.g., from memory 2210 (as nonlimiting examples, internal storage, an internal database, etc.), from external storage 2212 connected locally or over the network 906. For navigation training, devices 2204 may receive images such as observation images from one or more image-capturing devices, such as cameras (e.g., RGB cameras), or goals from one or more goal sources. The example training methods can generate a retrieval-enhanced navigation system or portion thereof that can be likewise stored in the server (e.g., memory 2210), devices 2204, external storage 2212, or combination. In some example embodiments provided herein, training may be performed offline or online (e.g., at run time), in any combination. Training and/or inference may be performed in a physical, virtual, and/or simulated environment.

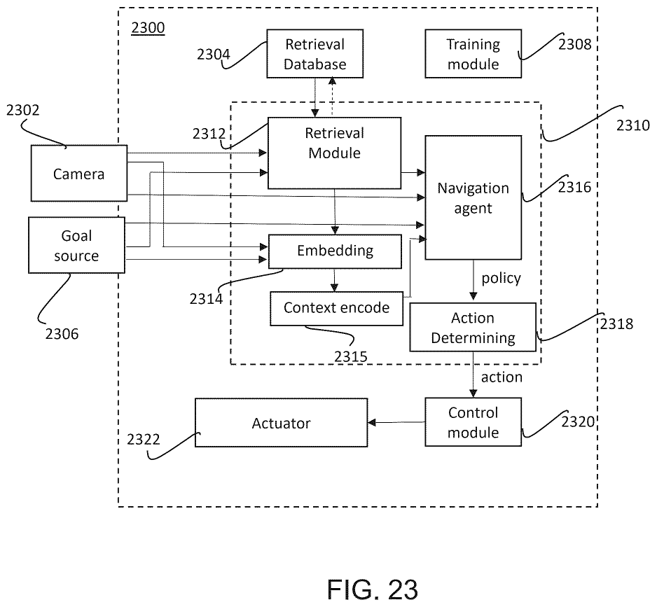

FIG. 23 shows an example retrieval-enhanced navigation system 2300 that may be incorporated into a device such as an autonomous apparatus (e.g., vehicle 2204d or robot 2204c). The retrieval-enhanced navigation system 2300 may comprise an image-capturing device such as a camera 2302 having an optical sensor, which generates an image of the surroundings of the autonomous apparatus, e.g., a first-person view (FPV) that may provide an observation image at each of a series of time-steps. A second image, which may provide a goal image, may be received via any suitable input, e.g., via goal source 2306, and stored in a memory such as a database, e.g., database 2304, or any other database storage which may be embodied in memory 2210. The stored second image may have been generated by the camera 2302 at an earlier time, or provided as an image that had not previously been obtained by the camera (such as when the device may be navigation to a new goal). If the goal to be provided is a categorical goal, e.g., represented by text, this goal can likewise be provided by the goal source 2306, which may be embodied in any suitable input (external memory, camera, microphone with sound processing, mouse, scanner, keyboard, or other suitable input device) and stored in a memory such as a database, e.g., database 2304, or any other database storage which may be embodied in memory 2210.

The autonomous apparatus, alone or via communication with another device 2204 or server 2202, may train, e.g., using training module 2308, a navigation architecture 2310 embodied in a machine learning model for a downstream navigation task according to method 200. The retrieval-enhanced navigation system 2310 may include a trained retrieval module 2312 (an example of retrieval modules 108 and 406), a database 2304 that includes a retrieval database (an example of retrieval databases 104 and 404, a trained embedding module 2314 (an example of models 115, 430, and 432), a context encoder 2315 (an example of context encoder 114 and 420), a trained navigation agent 2316 (an example of agent 102 and 402, with GRU 414), and an action determining module 2318 (an example of agent 102 and 402, and policy 416). Alternatively, the autonomous apparatus may receive from the server 2202 a trained navigation architecture trained by the server, e.g., using training module 130, 2308 (or similar model for system 2300) or by another device according to method 200. Updated models including parameters may be stored in memory 2210.

The autonomous apparatus may apply the trained task specific machine learning model to one or more images (or other data) obtained from the camera 2302, the goal source 2306, and/or from the database 2304 as needed to extract prediction data from the one or more images according to the navigation task. The autonomous apparatus may then adapt its motion state (e.g., velocity or direction of motion) or its operation based on the extracted prediction data. For example, an action output from the navigation architecture 2310, e.g., from the action determining module 2318, can be received by a control module (controller) 2320. The control module 2320 is configured to control operation of an actuator 2322, e.g., a propulsion device, to navigate the autonomous apparatus 2300 toward the goal indicated by the goal image.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

Embodiments herein provide, among other things, a computer-implemented method for performing a goal-oriented visual navigation task for an autonomous device in a three-dimensional navigation environment, comprising: receiving an observation image; retrieving a set of images from an image database based on at least a goal; comparing the retrieved set of images to at least the received observation image; encoding a context based on said comparing; updating a current state of an agent based on at least the goal, observation image, previous states and actions, and the encoded context; determining a next action based on the current state with a learned policy for navigating the agent; and outputting the determined next action to a control module for controlling movement of the autonomous device. In addition to any one or more of the above embodiments in this paragraph, determining the next action may comprise selecting the next action from an action space of discrete possible actions. In addition to any one or more of the above embodiments, the images in the image database may comprise previously collected first person view (FPV) images. In addition to any one or more of the above embodiments in this paragraph, the images in the image database may be generated by the agent or by similar agents in one or more previous navigation episodes in an environment that is the same as the navigation environment. In addition to any one or more of the above embodiments in this paragraph, the goal may be a goal image, and said retrieving may comprise retrieving similar images to the goal image from the image database based on global image similarity. In addition to any one or more of the above embodiments in this paragraph, the method may further comprise receiving the goal image as an initial goal, and the comparing may further comprise comparing the retrieved set of images to the goal image. In addition to any one or more of the above embodiments in this paragraph, the received goal image may originate from a different camera, platform, or domain than a device used to generate the received observation image. In addition to any one or more of the above embodiments in this paragraph, the method may further comprise: receiving a task goal; and retrieving the goal image from the image database based on the received task goal. In addition to any one or more of the above embodiments in this paragraph, the retrieved goal image from the image database may originate from a different camera, platform, or domain than a device used to generate the received observation image. In addition to any one or more of the above embodiments in this paragraph, the retrieved goal image from the image database is selected from the image database based on similarity to a received goal image to substitute for the received goal image. In addition to any one or more of the above embodiments in this paragraph, the received goal may be represented by text, and said retrieving may comprise retrieving images in the image database that are semantically similar to the text. In addition to any one or more of the above embodiments in this paragraph, the method may further comprise determining semantic similarity between the images in the image database and the received goal using a visual language model (VLM). In addition to any one or more of the above embodiments in this paragraph, the VLM may comprise CLIP. In addition to any one or more of the above embodiments in this paragraph, retrieving may comprise: selecting a shortlist of images from the image database; and reranking the shortlist to improve diversity of the shortlist. In addition to any one or more of the above embodiments in this paragraph, said retrieving may be further based on the received observation image. In addition to any one or more of the above embodiments in this paragraph, said retrieving may comprise: constructing a representation of similarity between the set of images; determining a first image similar to the goal and a second image similar to the observation image; and selecting the set of images using the determined first image, the determined second image, and a path between the first image and the second image. In addition to any one or more of the above embodiments in this paragraph, the first image, the second image, and/or the selected set of images may be intermediate goals between the observation image and the goal. In addition to any one or more of the above embodiments in this paragraph, encoding a context may use one or more of the selected set of images as pseudo-waypoints based on embeddings computed from the observation image and the goal. In addition to any one or more of the above embodiments in this paragraph, comparing the retrieved set of images to at least the received observation image may generate context embeddings for each of the retrieved set of images. In addition to any one or more of the above embodiments in this paragraph, the context embeddings may comprise relative pose and/or visibility information respectively between each of the retrieved set of images and the observation image and/or the goal. In addition to any one or more of the above embodiments in this paragraph, the goal may be a goal image; and comparing the retrieved set of images to at least the received observation image may further comprise comparing the retrieved set of images to the goal image. In addition to any one or more of the above embodiments in this paragraph, encoding a context may comprise: selecting one or a subset of the images from the retrieved set of images based on the generated context embeddings; and encoding the context using the generated context embeddings for the selected one or a subset of the images. In addition to any one or more of the above embodiments in this paragraph, said encoding a context may further comprise combining one or more of the generated context embeddings. In addition to any one or more of the above embodiments in this paragraph, said comparing the retrieved set of images to at least the received observation image may further comprise comparing feature vectors. In addition to any one or more of the above embodiments in this paragraph, said comparing the retrieved set of images to at least the received observation image may use a geometric foundation model. In addition to any one or more of the above embodiments in this paragraph, the autonomous device may comprise a robot or autonomous vehicle. In addition to any one or more of the above embodiments in this paragraph, the learned policy may be a recurrent policy. In addition to any one or more of the above embodiments in this paragraph, retrieving a set of images may be performed by a retrieval module, said comparing the retrieved set of images to at least the received observation image may be performed by a visual foundation model, and the learned policy may be trained using proximal policy optimization (PPO) while the retrieval module and the visual foundation model are frozen.. In addition to any one or more of the above embodiments in this paragraph, end-to-end training of the learned policy may occur while the context encoding module is trained and while the retrieval module and the embedding module are frozen.

Other embodiments provide, among other things, an apparatus comprising: a processor and a memory; and computer-readable instructions stored in said memory and executable by said processor to perform a method according to any one of more of the embodiments in the preceding paragraph.

Additional embodiments provide, among other things, a navigation system including a retrieval-augmented agent in an autonomous device, the retrieval-augmented agent receiving as an input a goal in a three-dimensional navigation environment, the navigation system comprising: an image database comprising a dataset of images; a retrieval module that retrieves a set of images from said image database based at least on a goal; an embedding module that compares the retrieved set of images to at least a received observation image and generates embeddings for the retrieved set of images; a context encoding module that generates a context based on the generated embeddings; a navigation module that updates a current state of the retrieval-augmented agent based at least on the context, the goal, a current observation, and previous states and actions; and an action determining module that determines a next action based on the current state with a learned policy for navigating the agent in the environment and outputs the selected next action to a control module for controlling movement of the autonomous device. In addition to any one or more of the above embodiments in this paragraph, determining the next action may comprise selecting the next action from an action space of discrete possible actions. In addition to any one or more of the above embodiments in this paragraph, the images in the image database may comprise previously-collected first person view (FPV) images. In addition to any one or more of the above embodiments in this paragraph, the images in the image database may be collected by the retrieval-augmented agent or by similar agents in one or more previous navigation episodes in an environment that is the same as the navigation environment. In addition to any one or more of the above embodiments in this paragraph, the goal may be a goal image, the retrieval module may retrieve similar images from the dataset to the goal image based on global image similarity, the retrieval-augmented agent receives the goal image as an initial goal, and the embedding module may compare the retrieved set of images to the goal image. In addition to any one or more of the above embodiments in this paragraph, the goal image may be received as an initial goal. In addition to any one or more of the above embodiments in this paragraph, the goal image may be retrieved from the dataset based on a received task goal. In addition to any one or more of the above embodiments in this paragraph, the goal may be a received goal represented by text, and the retrieval module may retrieve images in the image database that are semantically similar to the received goal and rank similarities between the received goal and the retrieved semantically similar images. In addition to any one or more of the above embodiments in this paragraph, the retrieval module may comprise a visual language model (VLM) for determining semantic similarity between the images in the image database and the received goal. In addition to any one or more of the above embodiments in this paragraph, the retrieval module may select a shortlist of images from the database and reranks the shortlist to improve diversity of the shortlist. In addition to any one or more of the above embodiments in this paragraph, the retrieval module may retrieve a set of images from said image database further based on a current observation. In addition to any one or more of the above embodiments in this paragraph, the retrieval module may further construct a representation of similarity between the set of images; determine a first image similar to the goal and a second image similar to the observation image; and select the set of images using the determined first image, the determined second image, and a path between the first image and the second image. In addition to any one or more of the above embodiments in this paragraph, the first image and the second image may be intermediate goals between the observation image and the goal. In addition to any one or more of the above embodiments in this paragraph, the learned policy may be a recurrent policy, and the navigation module may comprise a gated recurrent unit (GRU). In addition to any one or more of the above embodiments in this paragraph, the embedding module may further compare the retrieved set of images to the goal. In addition to any one or more of the above embodiments in this paragraph, the embedding module may comprise a geometric foundation model. In addition to any one or more of the above embodiments in this paragraph, the retrieval-augmented navigation agent may be embodied in a robot or autonomous vehicle. In addition to any one or more of the above embodiments in this paragraph, the system may further comprise: a binocular encoder comprising: first and second twin encoders; and a binocular decoder that is connected to the first and second twin encoders; wherein the first twin encoder encodes a first image, the second twin encoder encodes a second image, and the binocular encoder provides an input to the navigation module based on the encoded first and second images; wherein the system further comprises a training module configured to train the retrieval-augmented navigation agent; wherein said binocular encoder is pretrained on a first pretext task comprising a masked patch reconstruction task between image pairs of first images and second images, wherein the first images are masked; wherein said binocular encoder is finetuned on a second pretext task comprising a relative pose estimation between the first and second images and a visibility prediction, wherein the first twin encoder encodes the observation image as the first image and the second twin encoder encodes the goal image as the second image; wherein, when said training module trains the retrieval-augmented navigation agent, the first twin encoder encodes the observation image as the first image and the second twin encoder encodes the goal image as the second image.

Other embodiments provide, among other things, an autonomous device comprising: the retrieval-augmented navigation system according to any one or more of the embodiments in the preceding paragraph; an actuator; at least one image capturing device for obtaining the observation image; and a control module that receives a determined action from the action selection module and controls the actuator.

### General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. All publications, patents, and patent applications referred to herein are hereby incorporated by reference in their entirety, without an admission that any of such publications, patents, or patent applications necessarily constitute prior art.

It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between features (e.g., between modules, circuit elements, semiconductor layers, etc.) may be described using various terms, such as “connected,” “engaged,” “coupled,” “adjacent,” “next to,” “on top of,” “above,” “below,” “disposed”, and similar terms. Unless explicitly described as being “direct,” when a relationship between first and second features is described in the disclosure herein, the relationship can be a direct relationship where no other intervening features are present between the first and second features, or can be an indirect relationship where one or more intervening features are present, either spatially or functionally, between the first and second features, where practicable. As used herein, the phrase “at least one of” A, B, and C or the phrase “at least one of” A, B, or C, should be construed to mean a logical (A OR B OR C), using a non-exclusive logical OR, and should not be construed to mean “at least one of A, at least one of B, and at least one of C.”

In the figures, the direction of an arrow, as indicated by an arrowhead, generally demonstrates an example flow of information, such as data or instructions, that is of interest to the illustration. A unidirectional arrow between features does not imply that no other information may be transmitted between features in the opposite direction.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for performing a goal-oriented visual navigation task for an autonomous device in a three-dimensional navigation environment, the method comprising:
receiving an observation image;
retrieving a set of images from an image database based on at least a goal;
comparing the retrieved set of images to at least the received observation image;
encoding a context based on said comparing;
updating a current state of an agent based on at least the goal, observation image, previous states and actions, and the encoded context;
determining a next action based on the current state with a learned policy for navigating the agent; and
outputting the determined next action to a control module for controlling movement of the autonomous device.

2. The method of claim 1, wherein said determining the next action comprises selecting the next action from an action space of discrete possible actions.

3. The method of claim 1, wherein the images in the image database comprise previously collected first person view (FPV) images;
wherein the images in the image database are generated by the agent or by similar agents in one or more previous navigation episodes in an environment that is the same as the navigation environment.

4. The method of claim 1, wherein the goal is a goal image, and wherein said retrieving comprises retrieving similar images to the goal image from the image database based on global image similarity.

5. The method of claim 4, further comprising:
receiving the goal image as an initial goal; and
wherein the comparing further comprises comparing the retrieved set of images to the goal image.

6. The method of claim 5, wherein the received goal image originates from a different camera, platform, or domain than a device used to generate the received observation image.

7. The method of claim 4, further comprising:
receiving a task goal; and
retrieving the goal image from the image database based on the received task goal.

8. The method of claim 7, wherein the retrieved goal image from the image database originates from a different camera, platform, or domain than a device used to generate the received observation image.

9. The method of claim 7, wherein the retrieved goal image from the image database is selected from the image database based on similarity to a received goal image to substitute for the received goal image.

10. The method of claim 1, wherein the received goal is represented by text, and wherein said retrieving comprises retrieving images in the image database that are semantically similar to the text.

11. The method of claim 1, wherein said retrieving comprises:
selecting a shortlist of images from the image database; and
reranking the shortlist to improve diversity of the shortlist.

12. The method of claim 1 wherein said retrieving is further based on the received observation image.

13. The method of claim 12, wherein said retrieving comprises:
constructing a representation of similarity between the set of images;
determining a first image similar to the goal and a second image similar to the observation image; and
selecting the set of images using the determined first image, the determined second image, and a path between the first image and the second image.

14. The method of claim 13, wherein the first image, the second image and/or the selected set of images are intermediate goals between the observation image and the goal.

15. The method of claim 14, wherein said encoding a context uses one or more of the selected set of images as pseudo-waypoints based on embeddings computed from the observation image and the goal.

16. The method of claim 1,
wherein said comparing the retrieved set of images to at least the received observation image generates context embeddings for each of the retrieved set of images.

17. The method of claim 16, wherein the context embeddings comprise relative pose and/or visibility information respectively between each of the retrieved set of images and the observation image and/or the goal.

18. The method of claim 1, wherein the autonomous device comprises a robot or autonomous vehicle.

19. The method of claim 1,
wherein said retrieving a set of images is performed by a retrieval module;
wherein said comparing the retrieved set of images to at least the received observation image is performed by a visual foundation model; and
wherein the learned policy is trained using proximal policy optimization (PPO) while the retrieval module and the visual foundation model are frozen.

20. A navigation system including a retrieval-augmented agent in an autonomous device, the retrieval-augmented agent receiving as an input a goal in a three-dimensional navigation environment, the navigation system comprising:
an image database comprising a dataset of images;
a retrieval module that retrieves a set of images from said image database based at least on a goal;
an embedding module that compares the retrieved set of images to at least a received observation image and generates embeddings for the retrieved set of images;
a context encoding module that generates a context based on the generated embeddings;
a navigation module that updates a current state of the retrieval-augmented agent based at least on the context, the goal, a current observation, and previous states and actions; and
an action determining module that determines a next action based on the current state with a learned policy for navigating the agent in the environment and outputs the selected next action to a control module for controlling movement of the autonomous device.

21. The system of claim 20, wherein the images in the image database comprise previously-collected first person view (FPV) images.

22. The system of claim 20, wherein:
the goal is a goal image;
the retrieval module retrieves similar images from the dataset to the goal image based on global image similarity;
the retrieval-augmented agent receives the goal image as an initial goal; and
the embedding module compares the retrieved set of images to the goal image.

23. The system of claim 20, wherein the goal is a received goal represented by text, and wherein the retrieval module retrieves images in the image database that are semantically similar to the received goal and ranks similarities between the received goal and the retrieved semantically similar images;
wherein the retrieval module comprises a visual language model (VLM) for determining semantic similarity between the images in the image database and the received goal.

24. The system of claim 20, wherein the retrieval module further constructs a representation of similarity between the set of images; determines a first image similar to the goal and a second image similar to the observation image; and selects the set of images using the determined first image, the determined second image, and a path between the first image and the second image;
wherein the first image and the second image are intermediate goals between the observation image and the goal.

25. The system of claim 20, wherein the learned policy is a recurrent policy, and wherein the navigation module comprises a gated recurrent unit (GRU).

26. The system of claim 20, wherein said embedding module comprises a geometric foundation model (FM).

27. The system of claim 20, wherein the retrieval-augmented navigation agent is embodied in a robot or autonomous vehicle.

28. The system of claim 20, further comprising:
a binocular encoder comprising:
first and second twin encoders; and
a binocular decoder that is connected to the first and second twin encoders;
wherein the first twin encoder encodes a first image, the second twin encoder encodes a second image, and the binocular encoder provides an input to the navigation module based on the encoded first and second images;
wherein the system further comprises a training module configured to train the retrieval-augmented navigation agent;
wherein said binocular encoder is pretrained on a first pretext task comprising a masked patch reconstruction task between image pairs of first images and second images, wherein the first images are masked;
wherein said binocular encoder is finetuned on a second pretext task comprising a relative pose estimation between the first and second images and a visibility prediction, wherein the first twin encoder encodes the observation image as the first image and the second twin encoder encodes the goal image as the second image;
wherein, when said training module trains the retrieval-augmented navigation agent, the first twin encoder encodes the observation image as the first image and the second twin encoder encodes the goal image as the second image.

29. The system of claim 20, incorporated into an autonomous device and further comprising:
an actuator;
at least one image capturing device for obtaining the observation image; and
a control module that receives a determined action from the action selection module and controls the actuator.

30. An apparatus comprising:
a processor and a memory;
computer-readable instructions stored in said memory and executable by said processor to perform a method for performing a goal-oriented visual navigation task for an autonomous device in a three-dimensional navigation environment, the method comprising:
receiving an observation image;
retrieving a set of images from an image database based on at least a goal;
comparing the retrieved set of images to at least the received observation image;
encoding a context based on said comparing;
updating a current state of an agent based on at least the received goal, observation image, previous states and actions, and the encoded context;
determining a next action based on the current state with a learned policy for navigating the agent towards the location in the navigation environment indicated by the received goal; and
outputting the selected next action to a control module for controlling movement of an autonomous device.
